(19) United States
(12) Patent Application Publication
(10) Pub. No.: US 2011/0058612 A1
(43) Pub. Date: Mar. 10, 2011

(54) MOTION-VECTOR COMPUTATION APPARATUS, MOTION-VECTOR COMPUTATION METHOD AND MOTION-VECTOR COMPUTATION PROGRAM

(76) Inventor: Hiroshi YOSHIKAWA, Kanagawa (JP)

(21) Appl. No.: 12/868,911

(22) Filed: Aug. 26, 2010

(30) Foreign Application Priority Data
Sep. 7, 2009 (JP) P2009-205648

(51) Int. Cl. H04N 11/02

(52) U.S. Cl. 375/240.16; 375/E07.104

(57) ABSTRACT

A motion-vector computation apparatus includes: a motion-vector correction section configured to correct a referenced motion vector to be used in a process to compute a motion vector of a second macro block pair so as to make the referenced motion vector compatible with a specific structure; a motion-vector holding section configured to store the referenced motion vector corrected to a motion vector compatible with the specific structure at an address determined in accordance with the structure of a first macro block pair; and a motion-vector computation section configured to read out the referenced motion vector from the motion-vector holding section in accordance with the structure of the second macro block pair and compute a motion vector of the second macro block pair on the basis of the referenced motion vector read out from the motion-vector holding section.

### BACKGROUND OF THE INVENTION

1. Field of the Invention

In general, the present invention relates to a motion-vector computation apparatus, a motion-vector computation method and a motion-vector computation program. More particularly, the present invention relates to a motion-vector computation apparatus for computing a motion vector for a frame by taking each of blocks composing the frame as a motion-vector computation unit, relates to a motion-vector computation method adopted by the motion-vector computation apparatus and relates to a motion-vector computation program to be executed by a computer in order to implement the motion-vector computation method.

2. Description of the Related Art

The MPEG (Moving Picture Expert Group) method and the H.264 method have each been known so far as a compression/coding method for compressing and coding moving-picture data. In these compression/coding methods, each of frames composing moving-picture data is divided into a plurality of blocks which are each also referred to as a macro block. In accordance with these compression/coding methods, the macro block is used as a motion-vector computation unit in carrying out an encoding or decoding process on the frames. In a typical decoding process known so far for example, first of all, a motion vector is computed by carrying out prediction processing to predict the motion vector for each of macro block units which compose a frame. Then, the decoding process is carried out to decode the frames in order to produce the moving-picture data on the basis of the computed motion vectors.

For example, there has been known an inter-frame prediction processing apparatus for calculating an address in a memory used for storing a motion vector of a referenced object, reading out the motion vector of the referenced object from the address in the memory and computing a predicted value of the motion vector. For more information on the inter-frame prediction processing apparatus, the reader is advised to refer to documents such as Japanese Patent Laid-Open No. 2008-48289 (FIG. 1).

### SUMMARY OF THE INVENTION

In accordance with the related-art technology described above, the inter-frame prediction processing apparatus is capable of calculating an address in a memory used for storing a motion vector of a referenced object and reading out the motion vector of the referenced object from the address in the memory. It is thus possible to compute a predicted value of the motion vector at a high speed.

In this case, in accordance with the H.264 method for example, it is possible to select a mode for an encoding process carried out in frame units or a mode for an encoding process carried out in field units. In addition, the H.264 method also offers an MBAFF (Macro Block Adaptive Frame/Field) coding mode in which it is possible to switch the encoding mode from a field prediction mode to a frame prediction mode and vice versa for every macro block pair. A macro block pair is a pair of two macro blocks adjacent to each other in the vertical direction. In the field prediction mode, a macro block on the upper side includes only top fields whereas a macro block on the lower side includes only bottom fields.

In an operation to compute a motion vector for a processing-subject macro block serving as a subject of prediction processing for example, it is necessary to reference motion vectors of surrounding macro blocks which are each also referred to as a referenced macro block. The referenced macro blocks are macro blocks surrounding the processing-subject macro block which serves as a subject of the prediction processing. This macro-block computation operation requires pixels of the processing-subject macro block serving as a subject of the prediction processing and motion vectors of referenced macro blocks adjacent to the processing-subject macro block in the frame structure. Thus, in the MBAFF mode for example, the address of the motion vector to be referenced as the motion vector of a referenced macro block changes in accordance with a combination of the field/frame mode of the processing-subject macro block and the field/frame modes of the surrounding macro blocks.

In addition, in the MBAFF mode, if the structure of a processing-subject macro block is different from the structure of a referenced macro block, it is necessary to carry out a correction process to adjust the value of the Y-axis direction component of the motion vector computed for a referenced macro block to the structure of the processing-subject macro block and, then, carry out prediction processing on the motion vector. In this case, for the motion vector of a certain macro block for example, it is quite within the bounds of possibility that the four referenced macro blocks are referenced, requiring a referencing operation to be carried out up to four times for the four referenced macro blocks respectively. Thus, each time the motion vector of a referenced macro block is referenced, the motion vector referenced as the motion vector of a referenced macro block is subjected to the correction process. As a result, it feared that the efficiency of the processing to predict the motion vector becomes poor.

As described above, in execution of an operation to predict a motion vector in the MBAFF mode, the operation may become complicated in accordance with the aforementioned combination of the field/frame mode of the processing-subject macro block and the field/frame modes of the surrounding macro blocks. Thus, it is important that the speed of the operation to predict a motion vector be increased for any of such combinations.

Addressing the problems described above, inventors of the present invention have proposed a motion-vector computation apparatus capable of computing a motion vector at a high speed in a motion-vector prediction process and proposed a motion-vector computation method to be adopted in the motion-vector computation apparatus.

In order to solve the problems described above, in accordance with a first embodiment of the present invention, there are provided a motion-vector computation apparatus for computing a motion vector, a motion-vector computation method adopted by the motion-vector computation apparatus and a motion-vector computation program to be executed by a computer for implementing the motion-vector computation method. The motion-vector computation apparatus includes a motion-vector correction section configured to correct a referenced motion vector to be used in a process to compute a motion vector of a second macro block pair so as to make the referenced motion vector compatible with a specific structure. The referenced motion vector is one of motion vectors already computed for a first macro block pair. Each of the first and second macro block pairs is a macro block pair having a frame structure or a field structure. The macro block pairs each having a frame structure or a field structure are each a macro block pair obtained as a result of respectively a frame or field encoding process carried out as encoding processing for every macro block pair by switching the encoding processing from the frame encoding process to the field encoding process and vice versa. The specific structure is either the frame structure or the field structure. The motion-vector computation apparatus further includes: a motion-vector holding section configured to store the referenced motion vector corrected to a motion vector compatible with the specific structure at an address determined in accordance with the structure of the first macro block pair; and a motion-vector computation section configured to read out the referenced motion vector from the motion-vector holding section in accordance with the structure of the second macro block pair and compute a motion vector of the second macro block pair on the basis of the referenced motion vector read out from the motion-vector holding section.

Thus, an effect is exhibited by the above configuration in which: the motion-vector correction section corrects the referenced motion vector to be used in a process to compute a motion vector of a second macro block pair so as to make the referenced motion vector compatible with the specific structure which can be a frame or field structure; the motion-vector holding section is used for storing the referenced motion vector corrected to a motion vector compatible with the specific structure at an address determined in accordance with the structure of the first macro block pair; and the motion-vector computation section reads out the referenced motion vector from the motion-vector holding section in accordance with the structure of the second macro block pair and computes a motion vector of the second macro block pair on the basis of the referenced motion vector read out from the motion-vector holding section.

In addition, another effect can be obtained in the first embodiment of the present invention by providing a configuration in which the motion-vector correction section takes the frame structure as the specific structure and corrects the referenced motion vector so as to make the referenced motion vector compatible with the frame structure. That is to say, in the first embodiment of the present invention, it is possible to exhibit the other effect by providing a configuration for correcting the referenced motion vector to a motion vector compatible with the frame structure.

On top of that, a further effect can be obtained in the first embodiment of the present invention by providing a configuration in which, if the first macro block pair has the field structure, the motion-vector correction section corrects the referenced motion vector by doubling the vertical-direction component of the referenced motion vector but, if the first macro block pair is a macro block pair having the frame structure, on the other hand, the motion-vector correction section does not correct the referenced motion vector. That is to say, in the first embodiment of the present invention, it is possible to exhibit the further effect by providing a configuration for doubling the vertical-direction component of the referenced motion vector of a first macro block pair having the field structure and by not correcting the referenced motion vector of a first macro block pair having the frame structure.

In addition, a still further effect can be obtained in the first embodiment of the present invention by providing the motion-vector computation section with: a motion-vector predicted-value computation section configured to compute a predicted value of a motion vector of the second macro block pair on the basis of the referenced motion vector read out from the motion-vector holding section; and a motion-vector predicted-value correction section configured to correct the predicted value of the motion vector so as to make the predicted value of the motion vector compatible with the field structure of the second macro block pair in case the second macro block pair has the field structure.

That is to say, in the first embodiment of the present invention, it is possible to exhibit the still further effect by providing a configuration in which: the motion-vector predicted-value computation section employed in the motion-vector computation section computes a predicted value of a motion vector of the second macro block pair on the basis of the referenced motion vector read out from the motion-vector holding section; and if the second macro block pair has, the motion-vector predicted-value correction section employed in the motion-vector computation section corrects the predicted value of the motion vector of the second macro block pair so as to make the predicted value of the motion vector compatible with the field structure of the second macro block pair.

On top of that, a still further effect can be obtained in the first embodiment of the present invention by providing a configuration in which, if the second macro block pair has the field structure, the motion-vector predicted-value correction section corrects the predicted value of the motion vector by halving the vertical-direction component of the predicted value of the motion vector but, if the second macro block pair has the frame structure, on the other hand, the motion-vector correction section does not correct the predicted value of the motion vector. That is to say, in the first embodiment of the present invention, it is possible to exhibit the still further effect by providing a configuration for halving the vertical-direction component of the predicted value of the motion vector of a second macro block pair having the field structure and by not correcting the predicted value of the motion vector of a second macro block pair having the frame structure.

In addition, a still further effect can be obtained in the first embodiment of the present invention by providing the motion-vector computation apparatus with a parameter determination section configured to determine parameters, which are to be used in deblocking mode processing related to the second macro block pair, on the basis of the referenced motion vectors read out from the motion-vector holding section and on the basis of a motion vector computed for the second macro block pair and corrected so as to make the motion vector compatible with the specific structure. That is to say, in the first embodiment of the present invention, it is possible to exhibit the still further effect by providing a configuration in which the parameter determination section determines parameters, which are to be used in deblocking mode processing to be carried out as processing related to the second macro block pair, on the basis of the referenced motion vectors read out from the motion-vector holding section and on the basis of a motion vector computed by the motion-vector computation section for the second macro block pair and corrected by the motion-vector correction section so as to make the motion vector compatible with the specific structure.

In accordance with the present invention, it is possible to exhibit an excellent effect of providing a high speed at which a process is carried out to compute a motion vector in motion-vector prediction processing.

### BRIEF DESCRIPTION OF THE DRAWINGS

FIG. 1 is a block diagram showing a typical functional configuration of a motion-vector computation apparatus according to a first embodiment of the present invention;

FIGS. 2A and 2B are a plurality of diagrams each showing a model of contents stored in a motion-vector buffer employed in the motion-vector computation apparatus according to the first embodiment of the present invention to serve as contents representing motion vectors;

FIGS. 3A and 3B are a plurality of block diagrams each showing a model of motion-vector flows in processing carried out by a motion-vector correction section employed in the motion-vector computation apparatus according to the first embodiment of the present invention in order to correct the Y-axis component of a motion vector;

FIGS. 4A and 4B are a plurality of block diagrams each showing a model of motion-vector flows in processing carried out by a motion-vector predicted-value computation section employed in the motion-vector computation apparatus according to the first embodiment of the present invention in order to compute a predicted value of a motion vector of a macro block which serves as the subject of the processing;

FIGS. 5A and 5B are a plurality of diagrams each showing a model of motion-vector flows in processing carried out by the motion-vector computation apparatus according to the first embodiment of the present invention to predict a motion vector;

FIGS. 6A to 6D are plurality of diagrams showing a model of motion-vector flows in processing to update a processing-subject macro block pair stored in the motion-vector storage area of the motion-vector buffer employed in the motion-vector computation apparatus according to the first embodiment of the present invention;

FIG. 7 is a diagram showing a model of motion-vector flows in processing to store motion vectors in a in the motion-vector storage area of the motion-vector buffer employed in the motion-vector computation apparatus according to the first embodiment of the present invention;

FIGS. 8A and 8B are plurality of diagrams each showing a model of motion-vector flows in processing to store motion vectors in the motion-vector storage area of the motion-vector buffer employed in the motion-vector computation apparatus according to the first embodiment of the present invention;

FIGS. 9A and 9B are plurality of diagrams each showing a model of motion-vector flows in processing to store motion vectors in the motion-vector storage area of the motion-vector buffer employed in the motion-vector computation apparatus according to the first embodiment of the present invention;

FIGS. 10A and 10B are plurality of diagrams each showing a model of motion-vector flows in processing to store motion vectors of a processing-subject macro block pair having the field structure in the motion-vector storage area of the motion-vector buffer employed in the motion-vector computation apparatus according to the first embodiment of the present invention;

FIGS. 11A and 11B are plurality of diagrams each showing a model of motion-vector flows in processing to store motion vectors of a processing-subject macro block pair having the frame structure in the motion-vector storage area of the motion-vector buffer employed in the motion-vector computation apparatus according to the first embodiment of the present invention;

FIGS. 12A and 12B are plurality of diagrams each showing a model of motion-vector flows in processing to store motion vectors of a processing-subject macro block pair in the motion-vector storage area of the motion-vector buffer employed in the motion-vector computation apparatus according to the first embodiment of the present invention for the next processing-subject macro block pair having an unknown structure;

FIGS. 13A and 13B are plurality of diagrams each showing a typical model of motion-vector flows in processing to load motion vectors from the motion-vector storage area of the motion-vector buffer employed in the motion-vector computation apparatus according to the first embodiment of the present invention to a processing-subject macro block pair;

FIGS. 14A and 14B are plurality of diagrams each showing a typical model of motion-vector flows from the motion-vector buffer to a processing-subject macro block pair in deblocking mode processing carried out by the motion-vector computation apparatus according to the first embodiment of the present invention;

FIG. 15 shows a flowchart representing the procedure of moving-picture decoding processing carried out by the motion-vector computation apparatus according to the first embodiment of the present invention;

FIG. 16 shows a flowchart representing the procedure of a moving-picture computation process carried out by the motion-vector computation apparatus according to the first embodiment of the present invention as a part of the moving-picture decoding processing represented by the flowchart shown in FIG. 15;

FIG. 17 shows a flowchart representing the procedure of a data storing process carried out by the motion-vector computation apparatus according to the first embodiment of the present invention as a part of the moving-picture decoding processing represented by the flowchart shown in FIG. 15; and

FIGS. 18A and 18B are plurality of diagrams each showing a model of a method for correcting a motion vector of a referenced frame in a direct mode process carried out by a motion-vector computation apparatus according to a second embodiment of the present invention.

### DETAILED DESCRIPTION OF THE PREFERRED EMBODIMENTS

Preferred embodiments of the present invention are explained in chapters which are arranged in the following order.

### 1. First Embodiment

This chapter explains control of motion-vector computation. To be more specific, this chapter explains typical computation of a motion vector in the MBAFF mode.

### 2. Second Embodiment

This chapter explains control of motion-vector computation in direct mode processing or explains typical computation of a motion vector in the direct mode.

### 1. First Embodiment

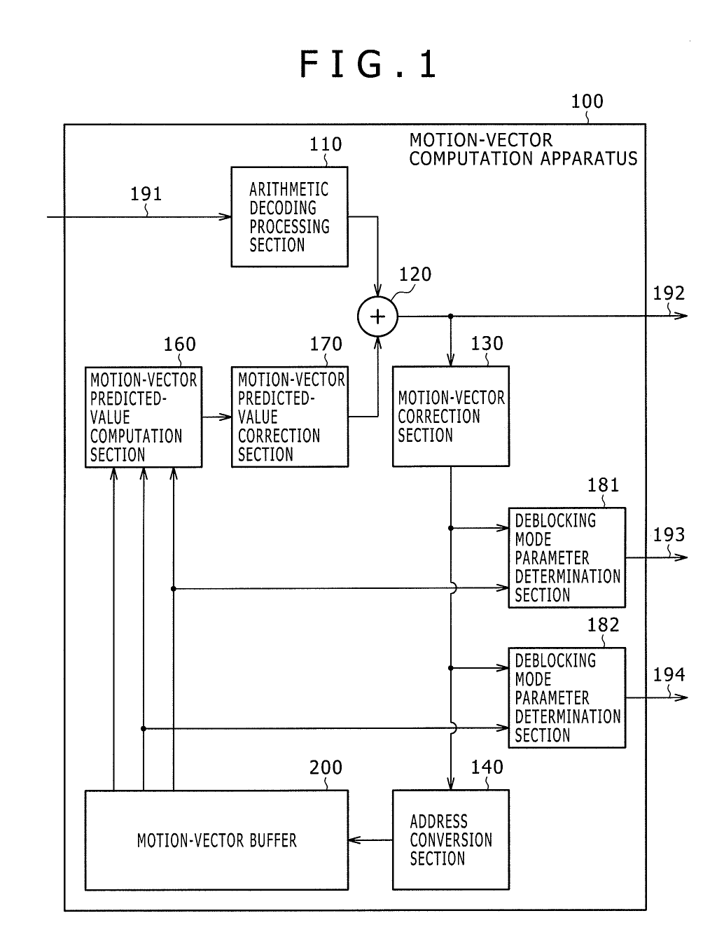

FIG. 1 is a block diagram showing a typical functional configuration of a motion-vector computation apparatus 100 according to a first embodiment of the present invention. As shown in the figure, the motion-vector computation apparatus 100 employs an arithmetic decoding processing section 110, an adder 120, a motion-vector correction section 130, an address conversion section 140 and a motion-vector buffer 200. In addition, the motion-vector computation apparatus 100 also has a motion-vector predicted-value computation section 160, a motion-vector predicted-value correction section 170, a deblocking mode parameter determination section 181 and a deblocking mode parameter determination section 182. The motion-vector computation apparatus 100 is an apparatus for computing motion vectors for a macro block pair which has either a frame structure or a field structure. The macro block pair having a frame structure is obtained as a result of a frame encoding process carried out in macro-block pair units whereas the macro block pair having a field structure is obtained as a result of a field encoding process carried out in macro-block pair units. In general, the encoding process can be switched from the frame encoding process to the field encoding process or vice versa.

The arithmetic decoding processing section 110 carries out a CABAC (Context-based Adaptive Binary Arithmetic Coding) process on a stream which is supplied to the arithmetic decoding processing section 110 through a signal line 191. Then, the arithmetic decoding processing section 110 finds a difference value Mvd from a motion vector predicted value Mvp generated by the motion-vector predicted-value correction section 170. Finally, the arithmetic decoding processing section 110 supplies the difference value Mvd from a motion vector predicted value Mvp to the adder 120.

The adder 120 adds a difference value received from the arithmetic decoding processing section 110 as the difference value Mvd from a motion vector predicted value Mvp to the motion vector predicted value Mvp which has been received from the motion-vector predicted-value correction section 170. Then, the adder 120 supplies a sum Mv obtained from the addition as the sum of the difference value Mvd and the motion vector predicted value Mvp and a deblocking mode processing section (not shown in FIG. 1) through a signal line 192. That is to say, the motion vector Mv of a macro block serving as the subject of processing is computed as follows:

Mv=Mvp+Mvd

In the following description, the macro block serving as the subject of processing is referred to as a processing-subject macro block.

The motion-vector correction section 130 is a processor for carrying out correction processing on the motion vector Mv received from the adder 120 so as to make the motion vector Mv compatible with a specific structure such as the aforementioned frame structure of the processing-subject macro block. To put it in detail, for a motion vector Mv computed for a processing-subject macro block having a field structure, the value of the Y-axis component of the motion vector Mv is doubled so that the Y-axis component of the motion vector Mv becomes compatible with the frame structure. It is to be noted that the Y-axis component of the motion vector Mv is the component in the vertical direction. For a motion vector Mv computed for a processing-subject macro block having a frame structure, on the other hand, the motion-vector correction section 130 does not carry out the correction processing.

The motion-vector correction section 130 supplies the motion vector Mv compatible with the frame structure to the address conversion section 140, the deblocking mode parameter determination section 181 and the deblocking mode parameter determination section 182. As described above, the correction processing is processing to merely double the value of the Y-axis component of the motion vector Mv. Thus, the motion-vector correction section 130 can be implemented by a 1-bit right-shift processor.

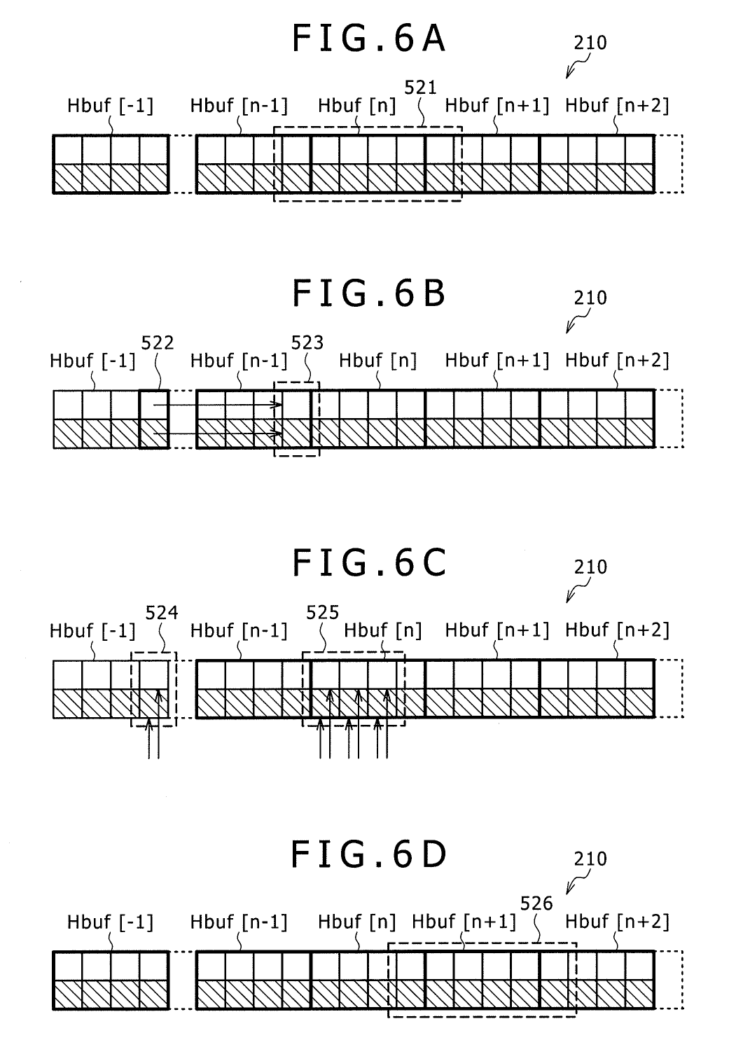

The address conversion section 140 determines an address in the motion-vector buffer 200 to be used as an address at which a motion vector Mv output by the motion-vector correction section 130 is to be stored. The address conversion section 140 then stores the motion vector Mv output by the motion-vector correction section 130 in the motion-vector buffer 200 at the address determined by the address conversion section 140. To put it more concretely, the address conversion section 140 determines the address in accordance with whether the structure of a macro block for which the motion vector Mv has been computed is the frame or field structure. It is to be noted that a method for determining the address will be described later in detail by referring to FIGS. 6A to 13B.

The motion-vector buffer 200 is used for storing a motion vector Mv output by the motion-vector correction section 130 at an address which has been determined by the address conversion section 140. A motion vector Mv stored in the motion-vector buffer 200 is read out from the motion-vector buffer 200 and supplied to the motion-vector predicted-value computation section 160, the deblocking mode parameter determination section 181 as well as the deblocking mode parameter determination section 182. To put it more concretely, the motion-vector buffer 200 provides the motion-vector predicted-value computation section 160 with a left upper referenced motion vector MvC which is a motion vector selected among motion vectors Mv stored in the motion-vector buffer 200. In addition, the motion-vector buffer 200 provides the motion-vector predicted-value computation section 160 and the deblocking mode parameter determination section 181 with a left-side referenced motion vector MvA which is also a motion vector selected among motion vectors Mv stored in the motion-vector buffer 200. On top of that, the motion-vector buffer 200 provides the motion-vector predicted-value computation section 160 and the deblocking mode parameter determination section 182 with an upper-side referenced motion vector MvB which is also a motion vector selected among motion vectors Mv stored in the motion-vector buffer 200.

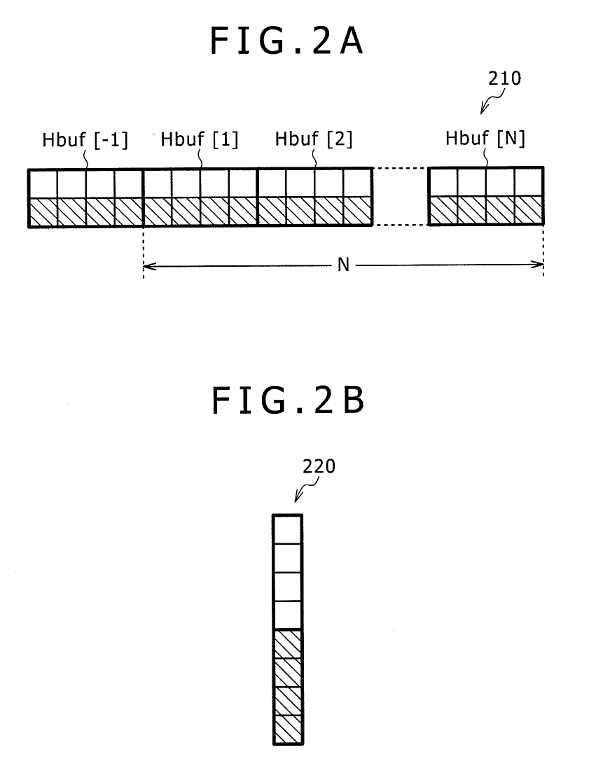

It is to be noted that contents stored in the motion-vector buffer 200 as contents representing the motion vectors Mv will be explained later in detail by referring to FIGS. 2A and 2B and FIGS. 6A to 13B. In addition, the motion-vector buffer 200 is a typical example of a motion-vector holding section described in a claim appended to this invention specification.

The motion-vector predicted-value computation section 160 computes a predicted value Mvp of a motion vector of a processing-subject macro block on the basis of motion vectors Mv stored in the motion-vector buffer 200. The motion vectors Mv stored in the motion-vector buffer 200 to be used as a basis in the computation of the motion-vector predicted value Mvp are the left upper referenced motion vector MvC, the left-side referenced motion vector MvA and the upper-side referenced motion vector MvB which are each a motion vector selected among motion vectors Mv stored in the motion-vector buffer 200 as described above.

In addition, the motion-vector predicted-value computation section 160 properly changes the motion vectors to be loaded from the motion-vector buffer 200 in accordance with whether the structure of the processing-subject macro block for which the motion vector Mv has been computed is the frame or field structure. Then, from the three motion vectors, that is, the left upper referenced motion vector MvC, the left-side referenced motion vector MvA and the upper-side referenced motion vector MvB, the motion-vector predicted-value computation section 160 selects a median value of the X-axis components of the motion vectors and a median value of Y-axis components of the motion vectors. Subsequently, the motion-vector predicted-value computation section 160 supplies the median values selected thereby to the motion-vector predicted-value correction section 170. Finally, the motion-vector predicted-value correction section 170 computes the motion-vector predicted value Mvp by making use of the median values received from the motion-vector predicted-value computation section 160.

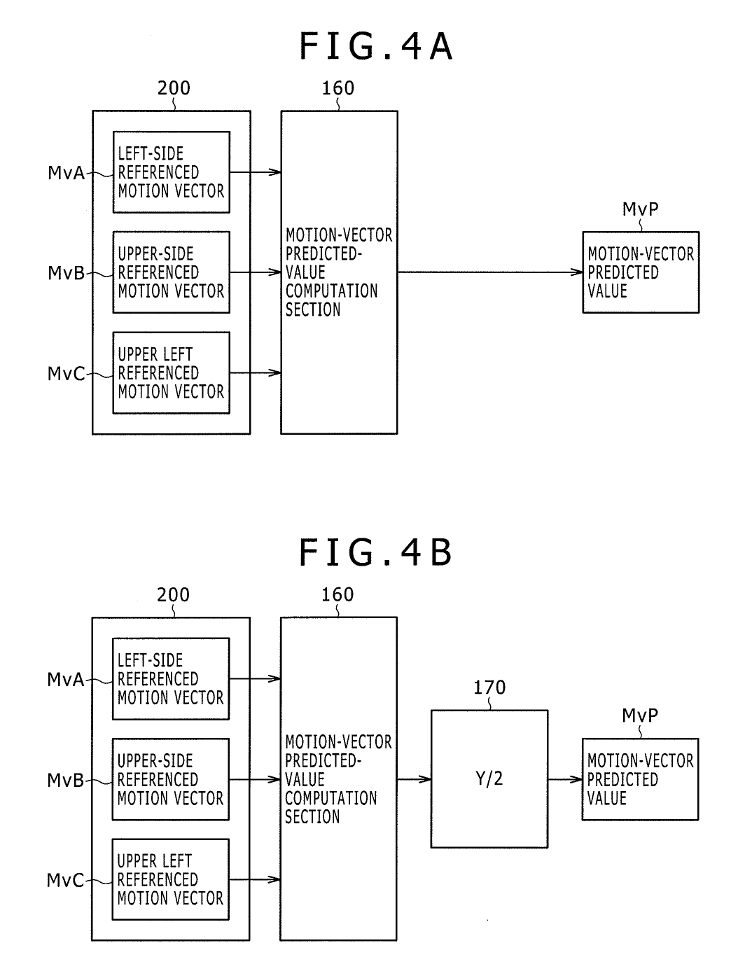

It is to be noted that a method for computing the motion-vector predicted value Mvp will be described later in detail by referring to, among others, FIGS. 4A and 4B.

The motion-vector predicted-value correction section 170 is a processor for carrying out a correction process according to the structure of the processing-subject macro block to correct the motion-vector predicted value Mvp which has been received from the motion-vector predicted-value computation section 160. This is because every motion vector Mv stored in the motion-vector buffer 200 is a motion vector compatible with the frame structure. Thus, the motion-vector predicted-value correction section 170 needs to carry out a correction process according to the structure of the processing-subject macro block.

To put it more concretely, if the structure of the processing-subject macro block is the field structure, the motion-vector predicted-value correction section 170 carries out the correction process by doubling the Y-axis component value of the motion-vector predicted value Mvp which has been received from the motion-vector predicted-value computation section 160. In this way, the Y-axis component value of the motion-vector predicted value Mvp is corrected to a value which is compatible with the frame structure.

If the structure of the processing-subject macro block is the frame structure, on the other hand, the motion-vector predicted-value correction section 170 does not carry out the correction process to correct the motion-vector predicted value Mvp which has been received from the motion-vector predicted-value computation section 160.

In either case, the motion-vector predicted-value correction section 170 supplies a motion-vector predicted value Mvp obtained as a result of the correction process according to the processing-subject macro block to the adder 120.

It is to be noted that the arithmetic decoding processing section 110, the adder 120, the motion-vector predicted-value computation section 160 and the motion-vector predicted-value correction section 170 form a typical example of a motion-vector computation section described in a claim appended to this invention specification. That is to say, the arithmetic decoding processing section 110, the adder 120, the motion-vector predicted-value computation section 160 and the motion-vector predicted-value correction section 170 read out a referenced motion vector from the motion-vector buffer 200 in accordance with the structure of the processing-subject macro block and compute the motion vector of the processing-subject macro block on the basis of the referenced motion vector read out from the motion-vector buffer 200.

The deblocking mode parameter determination section 181 is a section for determining a deblock strength parameter BsV of the processing-subject macro block. To put it in detail, the deblocking mode parameter determination section 181 determines a deblock strength parameter BsV of the processing-subject macro block by making use of a motion vector Mv received from the motion-vector correction section 130 and the left-side referenced motion vector MvA read out from the motion-vector buffer 200. The deblocking mode parameter determination section 181 then supplies the deblock strength parameter BsV determined thereby to a deblocking mode processing section not shown in FIG. 1 through the signal line 193.

By the same token, the deblocking mode parameter determination section 182 is a section for determining a deblock strength parameter BsH of the processing-subject macro block. To put it in detail, the deblocking mode parameter determination section 182 determines a deblock strength parameter BsH of the processing-subject macro block by making use of a motion vector Mv received from the motion-vector correction section 130 and the upper-side referenced motion vector MvB read out from the motion-vector buffer 200. The deblocking mode parameter determination section 182 then supplies the deblock strength parameter BsH determined thereby to a deblocking mode processing section not shown in FIG. 1 through the signal line 194.

A method for determining the deblock strength parameters BsV and BsH is explained as follows. Each of the deblock strength parameters BsV and BsH is a deblock parameter between processing-subject macro blocks which each do not have a Luma orthogonal conversion coefficient. The deblock strength parameter BsV is determined on the basis of the absolute value of the difference between the X-axis component of the motion vector Mv and the X-axis component of the left-side referenced motion vector MvA and the absolute value of the difference between the Y-axis component of the motion vector Mv and the Y-axis component of the left-side referenced motion vector MvA. By the same token, the deblock strength parameter BsH is determined on the basis of the absolute value of the difference between the X-axis component of the motion vector Mv and the X-axis component of the upper-side referenced motion vector MvB and the absolute value of the difference between the Y-axis component of the motion vector Mv and the Y-axis component of the upper-side referenced motion vector MvB.

To put it more concretely, if both the relation |MvAₓ−Mvₓ|<thₓ and the relation |MvA_{y}−Mv_{y}|<th_{y} hold true, the deblock strength parameter BsV is set at 0 (that is, BsV=0). If both the relation |MvAₓ−Mvₓ|<thₓ and the relation |MvA_{y}−Mv_{y}|<th_{y} do not hold true, on the other hand, the deblock strength parameter BsV is set at 1 (that is, BsV=1).

In the above relations, notation MvAₓ denotes the X-axis component of the left-side referenced motion vector MvA, notation MvA_{y} denotes the Y-axis component of the left-side referenced motion vector MvA, notation Mvₓ denotes the X-axis component of the motion vector Mv, notation Mv_{y} denotes the Y-axis component of the motion vector Mv, notation thₓ denotes a threshold value set for the X-axis direction whereas notation th_{y} denotes a threshold value set for the Y-axis direction.

By the same token, if both the relation |MvBₓ−Mvₓ|<thₓ and the relation |MvB_{y}−Mv_{y}|<th_{y} hold true, the deblock strength parameter BsH is set at 0 (that is, BsH=0). If both the relation |MvBₓ−Mvₓ|<thₓ and the relation |MvB_{y}−Mv_{y}|<th_{y} do not hold true, on the other hand, the deblock strength parameter BsH is set at 1 (that is, BsH=1).

In the above relations, notation MvBₓ denotes the X-axis component of the upper-side referenced motion vector MvB whereas notation MvB_{y} denotes the Y-axis component of the upper-side referenced motion vector MvB.

The threshold value thₓ for the X-axis direction and the threshold value th_{y} for the Y-axis direction are properly changed in accordance with the structure of the processing-subject-macro block. To put it more concretely, if the structure of the processing-subject macro block is the frame structure, the X-axis direction threshold value thₓ is set at 4 (that is, thₓ=4) whereas the Y-axis direction threshold value th_{y} is set at 4 (that is, th_{y}=4). If the structure of the processing-subject macro block is the field structure, on the other hand, the X-axis direction threshold value thₓ is set at 4 (that is, thₓ=4) whereas the Y-axis direction threshold value th_{y} is set at 2 (that is, th_{y}=2).

As described above, in the first embodiment of the present invention, each of the motion vector Mv output by the motion-vector correction section 130 and the left-side referenced motion vector MvA stored in the motion-vector buffer 200 is a motion vector compatible with the frame structure. In actuality, it is thus unnecessary to change the X-axis direction threshold value thₓ and the Y-axis direction threshold value th_{y} in accordance with the structure of the processing-subject macro block. That is to say, thₓ=4 and th_{y}=4 are used in determining the deblock strength parameter BsV and the deblock strength parameter BsH without regard to whether the structure of the processing-subject macro block is the frame or field structure. Thus, each of the deblock strength parameter BsV and the deblock strength parameter BsH can be determined at a high speed.

It is to be noted that each of the deblocking mode parameter determination sections 181 and 182 is a typical example of the parameter determination section described in a claim appended to this invention specification.

### Typical Contents of the Motion-Vector Buffer

FIGS. 2A and 2B are plurality of diagrams each showing a model of contents stored in the motion-vector buffer 200 employed in the motion-vector computation apparatus 100 according to the first embodiment of the present invention to serve as contents representing motion vectors Mv. To be more specific, FIG. 2A is a diagram showing a motion-vector storage area 210 included in the motion-vector buffer 200 to serve as an area used for storing motion vectors Mv arranged in the horizontal direction on a frame whereas FIG. 2B is a diagram showing a motion-vector storage area 220 included in the motion-vector buffer 200 to serve as an area used for storing motion vectors Mv arranged in the vertical direction on a frame.

The motion-vector storage area 210 shown in FIG. 2A is storage areas Hbuf used for storing upper-side referenced motion vectors MvB and left upper referenced motion vectors MvC. To put it more concretely, in the motion-vector storage area 210, an area Hbuf[i] used for storing eight motion vectors Mv associated with a macro block pair is used as a unit corresponding to the macro block pair. The motion-vector storage area 210 includes (N+1) successive such units where notation N denotes the number of macro blocks arranged in the horizontal direction to form a frame on a stream. That is to say, the motion-vector storage area 210 has N storage areas Hbuf[i], i.e., storage areas Hbuf[−1] to Hbuf[N]. It is to be noted that a macro block pair is a pair of macro blocks which are adjacent to each other in the vertical direction. The upper macro block in a macro block pair is shown as four white rectangular blocks whereas the lower macro block in the same macro block pair is shown as four hatched rectangular blocks. In the case of the typical storage areas Hbuf[i] of the motion-vector storage area 210 shown in FIG. 2A, each unit is associated with a macro block pair which is represented by eight rectangular blocks each corresponding to one motion vector Mv. Thus, every unit has eight motion vectors Mv. In addition, in the motion-vector storage area 210 shown in FIG. 2A, each unit including eight rectangular blocks is shown as a block enclosed by a bold line.

In this case, each of the four upper-side white rectangular blocks in every unit is a storage area used for storing a motion vector Mv of the top field whereas each of the four lower-side hatched rectangular blocks in every unit is a storage area used for storing a motion vector Mv of the bottom field.

In addition, as described above, notation N denotes an integer representing the number of macro blocks which are arranged in the horizontal direction to form a frame on a stream. In this case, the horizontal-direction position of a macro block or the horizontal-direction position of a unit associated with the macro block in the frame can be indicated by notation n where 1≦n≦N. For example, let n (=1) denote the horizontal-direction position of a macro block at the left end of the frame whereas n (=N) denote the horizontal-direction position of a macro block at the right end of the frame. In the frame, the N macro blocks are arranged in the left-to-right order which starts with the macro block positioned at the left end indicated by position 1 and ends at the macro block positioned at the right end indicated by position N. That is to say, the N macro blocks arranged in the left-to-right order to form a line in the frame are located at positions 1 to N respectively. A unit used in the following description represents one of the N macro blocks which are arranged in the left-to-right order to form a line in the frame and located at positions 1 to N respectively. In the following description for example, notation Hbuf[n] denotes a unit representing a specific macro block which is located at position n. The specific macro block located at position n is one the N macro blocks which are arranged in the left-to-right order to form a line in the frame and located at positions 1 to N respectively where 1≦n≦N.

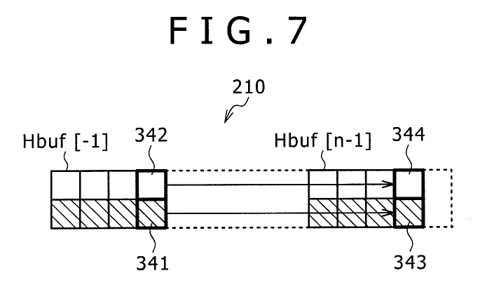

On top of that, in the case of the first embodiment, the motion-vector storage area 210 includes (N+1) successive units where notation N denotes the number of macro blocks arranged in the horizontal direction to form a frame on a stream. Thus, notation Hbuf[−1] denotes a unit representing the leftmost macro block shown in FIG. 2A. The unit Hbuf[−1] representing a pair of macro blocks stored in the storage area Hbuf[−1] will be described later in detail by referring to FIGS. 6A to 7.

The motion-vector storage area 220 shown in FIG. 2B is a storage area Vbuf used for storing left-side referenced motion vectors MvA associated with a pair of processing-subject macro blocks. The number of left-side referenced motion vectors MvA stored in the storage area Vbuf denoted by reference numeral 220 is a number determined in advance. In the motion-vector storage area 220 shown in FIG. 2B as a typical example, the pair of macro blocks has eight motion vectors.

In this case, each of the four upper-side white rectangular blocks in the motion-vector storage area 220 is a storage area used for storing a motion vector Mv of the top macro block of the macro block pair whereas each of the four lower-side hatched rectangular blocks in the motion-vector storage area 220 is a storage area used for storing a motion vector Mv of the bottom macro block of the macro block pair. In addition, in the motion-vector storage area 220 shown in FIG. 2B, each unit including eight rectangular blocks is shown as a block enclosed by a bold line.

For the motion vectors Mv stored in the motion-vector buffer 200 as described above, the motion-vector correction section 130 carries out correction processing so as to make the Y-axis component of each of the motion vectors Mv compatible with the frame structure. Thus, each of the motion vectors Mv is stored in the motion-vector buffer 200 in a state of being compatible with the frame structure.

Next, the following description explains effects which are exhibited as a result of fixing the Y-axis component of each of the motion vectors Mv stored in the motion-vector buffer 200 in a state of being compatible with the frame structure.

### Typical Correction of the Y-Axis Component of a Motion Vector

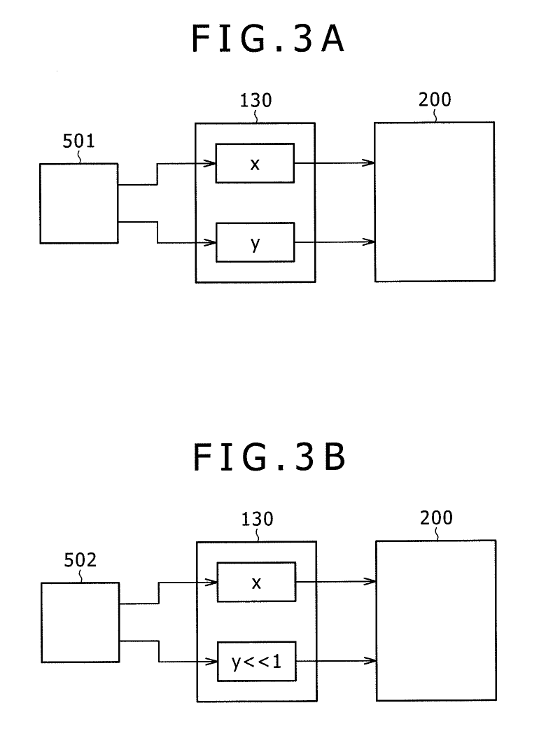

FIGS. 3A and 3B are plurality of block diagrams each showing a model of motion-vector flows in processing carried out by the motion-vector correction section 130 employed in the motion-vector computation apparatus 100 according to the first embodiment of the present invention in order to correct the Y-axis component of a motion vector. To be more specific, FIG. 3A is a block diagram showing a model of motion-vector flows in processing carried out by the motion-vector correction section 130 in order to correct the Y-axis component of a motion vector for a processing-subject macro block which has a frame structure whereas FIG. 3B is a block diagram showing a model of motion-vector flows in processing carried out by the motion-vector correction section 130 in order to correct the Y-axis component of a motion vector for a processing-subject macro block which has a field structure.

In the motion-vector flows shown in FIGS. 3A and 3B, the motion-vector correction section 130 corrects a motion vector Mv computed for a processing-subject macro block pair which is a pair of processing-subject macro blocks serving as the subject of processing. Then, the motion-vector correction section 130 stores the corrected motion vector Mv in the motion-vector buffer 200.

In motion-vector prediction processing carried out to find a motion vector Mv, a motion-vector predicted value Mvp is computed by making use of three motion vectors which have been calculated for macro blocks surrounding the processing-subject macro block. To put it more concretely, from the three motion vectors, that is, the left upper referenced motion vector MvC, the left-side referenced motion vector MvA and the upper-side referenced motion vector MvB, the motion-vector predicted-value computation section 160 selects a median value of the X-axis components of the left upper referenced motion vector MvC, the left-side referenced motion vector MvA and the upper-side referenced motion vector MvB as well as a median value of Y-axis components of the left upper referenced motion vector MvC, the left-side referenced motion vector MvA and the upper-side referenced motion vector MvB. Subsequently, the motion-vector predicted-value computation section 160 supplies the median values selected thereby to the motion-vector predicted-value correction section 170. Finally, the motion-vector predicted-value correction section 170 computes the motion-vector predicted value Mvp by making use of the median values received from the motion-vector predicted-value computation section 160.

In this case, there may be presumably a case in which, for the three aforementioned motion vectors computed for macro blocks surrounding the processing-subject macro block, the frame and field structures coexist. For such a case in which the frame and field structures coexist as they are, accurate median values cannot be found as a result of the process to select a median value of the X-axis components of the three aforementioned motion vectors and a median value of Y-axis components of the three aforementioned motion vectors. Thus, for a case in which the frame and field structures coexist for the three aforementioned motion vectors computed for the macro blocks surrounding the processing-subject macro block, correction processing is generally carried out in order to make the structures of the motion vectors uniform. Then, a median value of the X-axis components of the three aforementioned motion vectors and a median value of Y-axis components of the three aforementioned motion vectors are selected by making use of the motion vectors which are each obtained as a result of the correction processing.

As described above, there may be presumably a case in which, for the three aforementioned motion vectors computed for macro blocks surrounding the processing-subject macro block, the frame and field structures coexist. For such a case, every time the motion-vector prediction processing is carried out, it is generally necessary to carry out correction processing in order to make the structures of the motion vectors uniform. For example, it is quite within the bounds of possibility that one motion vector is referenced for a plurality of processing-subject macro blocks. If the correction processing is carried out prior to every referencing process on the motion vector referenced for a plurality of processing-subject macro blocks, it is feared that the efficiency of the motion-vector prediction processing deteriorates.

In order to solve the above problem of the deteriorating efficiency of the motion-vector prediction processing, in the first embodiment of the present invention, the value of the Y-axis component of every motion vector Mv to be stored in the motion-vector buffer 200 is corrected in advance so as to make the Y-axis component of every motion vector Mv compatible with the frame structure.

As is obvious from the motion-vector flows shown in FIG. 3A for example, the X-axis and Y-axis components of a motion vector computed for a processing-subject macro block 501 having the frame structure are not corrected. That is to say, the motion-vector correction section 130 does not carry out the correction processing on the X-axis and Y-axis components of a motion vector computed for a processing-subject macro block 501 having the frame structure. Then, the motion-vector correction section 130 stores the motion vector in the motion-vector buffer 200 as it is.

As another example, as is obvious from the motion-vector flows shown in FIG. 3B, on the other hand, the Y-axis component of a motion vector computed for a processing-subject macro block 502 having the field structure is corrected. That is to say, the motion-vector correction section 130 carries out the correction processing in order to double the value of the Y-axis component of a motion vector computed for a processing-subject macro block 502 having the frame structure but does not carry out the correction processing on the X-axis component of the motion vector. Then, the motion-vector correction section 130 stores the corrected motion vector in the motion-vector buffer 200.

### Typical Computation of a Motion-Vector Predicted Value

FIGS. 4A and 4B are plurality of block diagrams each showing a model of motion-vector flows in processing carried out by the motion-vector predicted-value computation section 160 employed in the motion-vector computation apparatus 100 according to the first embodiment of the present invention in order to compute a predicted value of a motion vector of a macro block which serves as the subject of the processing. To be more specific, FIG. 4A is a block diagram showing a model of motion-vector flows in computation processing carried out by the motion-vector predicted-value computation section 160 in order to compute a predicted value of a motion vector of the processing-subject macro block which has the frame structure. On the other hand, FIG. 4B is a block diagram showing a model of motion-vector flows in computation and correction processing carried out by the motion-vector predicted-value computation section 160 and a motion-vector predicted-value correction section 170 also employed in the motion-vector computation apparatus 100 according to the first embodiment of the present invention in order to compute and correct a predicted value of a motion vector of the processing-subject macro block which has the field structure. Each of FIGS. 4A and 4B shows simplified motion-vector flows in processing carried out in order to compute a predicted value of a motion vector of a macro block serving as the subject of the predicted-value computation processing by making use of referenced motion vectors which have already been stored in the motion-vector buffer 200.

As explained earlier by referring to FIGS. 3A and 3B, each of referenced motion vectors stored in the motion-vector buffer 200 has been fixed as a motion vector compatible with the frame structure. Thus, if the structure of the processing-subject macro block is the frame structure, as is obvious from the motion-vector flows shown in FIG. 4A, the predicted value of the motion vector of the processing-subject macro block is computed by merely selecting a median value of the referenced motion vectors MvA and MvC which have already been stored in the motion-vector buffer 200. That is to say, as is obvious from the motion-vector flows shown in FIG. 4A, the motion-vector predicted-value computation section 160 carries out processing to select a median value of the left-side referenced motion vector MvA and the left upper referenced motion vector MvC, which have been stored in the motion-vector buffer 200, in order to compute the predicted value of a motion vector of a macro block serving as the subject of the predicted-value computation processing.

If the structure of the processing-subject macro block is the field structure, on the other hand, as is obvious from the motion-vector flows shown in FIG. 4B, the motion-vector predicted-value computation section 160 also computes the predicted value of the motion vector of the processing-subject macro block by selecting a median value of the referenced motion vectors MvA and MvC which have already been stored in the motion-vector buffer 200. In the case of a processing-subject macro block having the field structure, however, the motion-vector predicted-value correction section 170 then carries out correction processing on the value of the Y-axis component of the selected median value and computes the predicted value of a motion vector of a macro block serving as the subject of the predicted-value computation processing on the basis of the corrected Y-axis component of the selected median value.

### Typical Data Loading in the Motion-Vector Prediction Processing

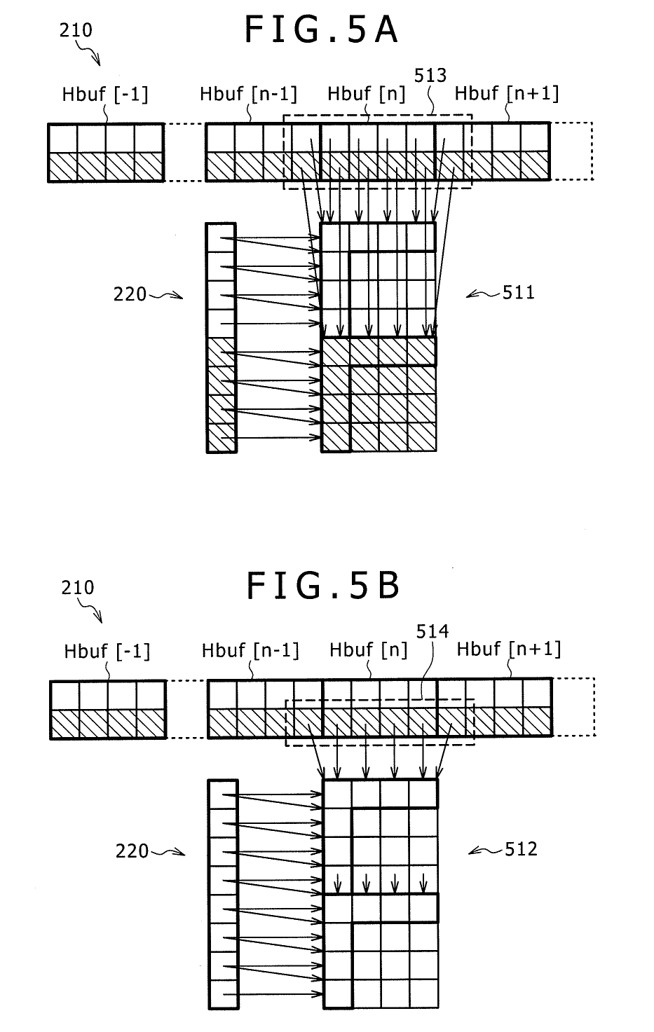

FIGS. 5A and 5B are a plurality of diagrams each showing a model of motion-vector flows in processing carried out by the motion-vector computation apparatus 100 according to the first embodiment of the present invention to predict a motion vector. To be more specific, FIG. 5A is a diagram showing a model of motion-vector flows in processing carried out by the motion-vector computation apparatus 100 from the motion-vector storage areas 210 and 220 of the motion-vector buffer 200 to a processing-subject macro block pair 511 which has the field structure. On the other hand, FIG. 5B is a diagram showing a model of motion-vector flows in processing carried out by the motion-vector computation apparatus 100 from the motion-vector storage areas 210 and 220 of the motion-vector buffer 200 to a processing-subject macro block pair 512 which has the frame structure.

The models shown in FIGS. 5A and 5B are each a typical model in which motion vectors stored in the motion-vector storage areas 210 and 220 of the motion-vector buffer 200 are used as referenced motion vectors. It is to be noted that, in the typical model shown in FIG. 5A, referenced motion vectors to be loaded from the motion-vector storage area 210 to the processing-subject macro block pair 511 having the field structure are shown as rectangular blocks enclosed by a dashed line 513. In the typical model shown in FIG. 5B, on the other hand, referenced motion vectors to be loaded from the motion-vector storage area 210 to the processing-subject macro block pair 512 having the frame structure are shown as rectangular blocks enclosed by a dashed line 514.

The motion-vector flows shown in FIG. 5A as motion-vector flows in motion-vector prediction processing carried out on a processing-subject pair 511 having the field structure are different from the motion-vector flows shown in FIG. 5B as motion-vector flows in motion-vector prediction processing carried out on a processing-subject pair 512 having the frame structure. As described earlier, however, the Y-axis component value of each of referenced motion vectors stored in the motion-vector buffer 200 has been fixed at the value of the Y-axis component of a motion vector compatible with the frame structure. In addition, each of referenced motion vectors has been stored in the motion-vector buffer 200 at an address determined in advance. It is thus possible to fix an address, from which a referenced motion vector is to be loaded, in accordance with the structure of the processing-subject macro block pair.

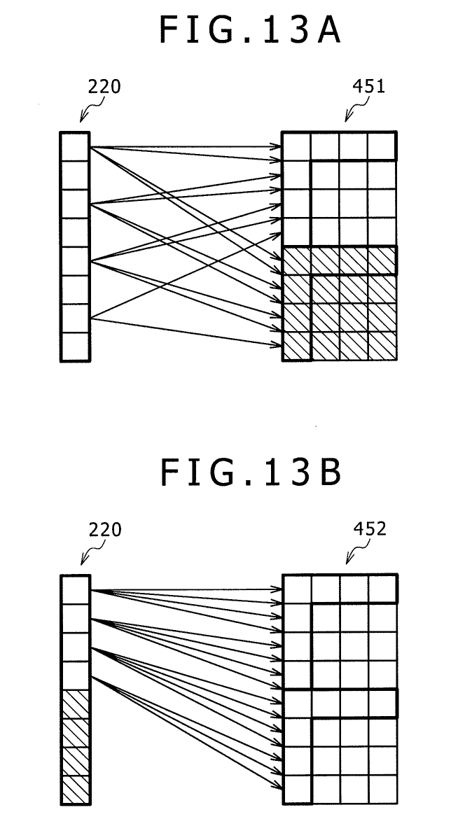

It is to be noted that the motion-vector flows shown in FIGS. 5A and 5B are motion-vector flows for a case in which the structure of the next processing-subject macro block pair has been determined. Motion-vector flows for a case in which the structure of the next processing-subject macro block pair has not been determined yet will be described later in detail by referring to FIGS. 13A and 13B.

### Typical Updating of Data Stored in the Motion-Vector Buffer

FIGS. 6A to 6D are plurality of diagrams showing a model of motion-vector flows in processing to update a processing-subject macro block pair stored in the motion-vector storage area 210 of the motion-vector buffer 200 employed in the motion-vector computation apparatus 100 according to the first embodiment of the present invention. To be more specific, FIG. 6A is a diagram showing a case in which the nth macro block pair in a frame is taken as the processing-subject macro block pair. As described earlier, successive macro block pairs stored in the motion-vector storage area 210 are arranged horizontally from the left to the right, forming the frame. The macro block pair at the left end of the frame is located at a position referred to as position 1 whereas the nth macro block pair cited above is a macro block pair located at position n which is the nth position shifted from position 1 in the horizontal direction to the right end of the frame. FIGS. 6B to 6D are diagrams showing a model of motion-vector flows in processing to update the processing-subject macro block pair stored in the motion-vector storage area 210 of the motion-vector buffer 200 from the nth macro block pair to the (n+1)th macro block pair after completion of motion-vector prediction processing carried out on the nth macro block pair.

An area 521 enclosed by a dashed line as shown in FIG. 6A is a referenced area used for storing motion vectors Mv which each serve as a current referenced motion vector. If the nth macro block pair in a frame is taken as the processing-subject macro block pair as shown in FIG. 6A for example, the units Hbuf[n−1] to Hbuf[n+1] in the motion-vector storage area 210 of the motion-vector buffer 200 serve as a referenced area 521 in the motion-vector prediction processing. To put it more precisely, a portion of the unit Hbuf[n−1], the entire unit Hbuf[n] and a portion of the unit Hbuf[n+1] are used as the referenced area 521 in the motion-vector prediction processing. That is to say, each of motion vectors Mv stored in storage areas included in the area 521 shown in FIG. 6A serves as a current referenced motion vector in the motion-vector prediction processing which has been explained earlier by referring to FIGS. 5A and 5B.

Then, after completion of the motion-vector prediction processing carried out on the nth macro block pair, two motion vectors MV stored in a portion 522 of the unit Hbuf[−1] held in the motion-vector storage area 210 are transferred to a portion 523 of the unit Hbuf[n−1] held in the motion-vector storage area 210 as shown in FIG. 6B. As shown in FIG. 6B, the portion 522 is a rectangular area at the right end of the unit Hbuf[−1] whereas the portion 523 is a rectangular area enclosed by a dashed line at the right end of the unit Hbuf[n−1]. That is to say, the address conversion section 140 transfers the two motion vectors Mv stored so far in the portion 522 to the portion 523.

Subsequently, as shown in FIG. 6C, the address conversion section 140 stores eight motion vectors MV each computed for the nth macro block pair in the units Hbuf[−1] and Hbuf[n] of the motion-vector storage area 210. To put it more concretely, the address conversion section 140 stores two motion vectors MV each computed for the (−1)th macro block pair in a rectangular area 524 enclosed by a dashed line in the unit Hbuf[−1] and six motion vectors MV each computed for the nth macro block pair in a rectangular area 525 enclosed by a dashed line in the unit Hbuf[−n]. Relations between motion vectors Mv and storage areas will be described later in detail by referring to FIGS. 7 to 9B.

Then, the motion-vector prediction processing is carried out for the (n+1)th macro block pair taken as the processing-subject macro block pair. When the (n+1)th macro block pair is taken as the processing-subject macro block pair, the units Hbuf[n] to Hbuf[n+2] in the motion-vector storage area 210 of the motion-vector buffer 200 become a referenced rectangular area 526 enclosed by a dashed line to serve as an area to be referenced to during the execution of the motion-vector prediction processing. As shown in FIG. 6D, the referenced rectangular area 526 includes a portion of the units Hbuf[n], the entire unit Hbuf[n+1] and a portion of the unit Hbuf[n+2]. That is to say, each of motion vectors Mv stored in storage areas included in the referenced rectangular area 526 shown in FIG. 6D serves as a current referenced motion vector in the motion-vector prediction processing which has been explained earlier by referring to FIGS. 5A and 5B.

The transition described above as a transition of the subject of the motion-vector prediction processing from the nth macro block pair to the (n+1)th macro block pair is carried out in the same way as a transition of the subject of the motion-vector prediction processing from any subsequent macro block pair to a macro block pair immediately following the subsequent macro block pair. In the sequence of macro block pairs shown in FIGS. 6A to 6D, a macro block pair immediately following the (n+1)th macro block pair is the (n+2)th macro block pair.

### Typical Operations to Store Data in Motion-Vector Storage Areas Arranged in the Horizontal Direction

FIGS. 7 to 9B are a plurality of diagrams each showing a typical model of motion-vector flows in processing to store motion vectors Mv in the motion-vector storage area 210 of the motion-vector buffer 200 employed in the motion-vector computation apparatus 100 according to the first embodiment of the present invention. In the first embodiment of the present invention, some of motion vectors Mv computed for processing-subject macro block pairs are each stored in the motion-vector storage areas 210 and 220 to serve as a motion vector Mv to be referenced in subsequent processing. In this case, every referenced motion vector Mv is stored in the motion-vector storage areas 210 and 220 as a motion vector Mv compatible with the field structure without regard to whether the structure of the processing-subject macro block pair is a frame or field structure.

To be more specific, the motion-vector flows in the typical model shown in FIG. 7 are motion-vector flows of processing to store motion vectors Mv in the unit Hbuf[n−1] of the motion-vector storage area 210 included in the motion-vector buffer 200. It is to be noted that the motion-vector flows shown in FIG. 7 are motion-vector flows of processing to store motion vectors Mv for a processing-subject macro block pair in the unit Hbuf[n−1] of the motion-vector storage area 210 included in the motion-vector buffer 200 without regard to whether the structure of the processing-subject macro block pair is a frame or field structure.

As shown in FIG. 6C, some of motion vectors Mv computed in a motion-vector computation process carried out immediately before the processing-subject macro blocks are stored at the right end of the unit Hbuf[−1]. For this reason, before these two motion vectors Mv computed in a motion-vector computation process carried out immediately before the processing-subject macro blocks are stored at the right end of the unit Hbuf[−1], two previous motion vectors Mv stored so far at the right end of the unit Hbuf[−1] are transferred to the right end of the unit Hbuf[n−1] as shown in FIG. 7. To put it more concretely, the previous motion vector Mv stored so far in a storage area 341 at the right end of the unit Hbuf[−1] are transferred to a storage area 343 at the right end of the unit Hbuf[n−1]. By the same token, the previous motion vector Mv stored so far in a storage area 342 at the right end of the unit Hbuf[−1] are transferred to a storage area 344 at the right end of the unit Hbuf[n−1].

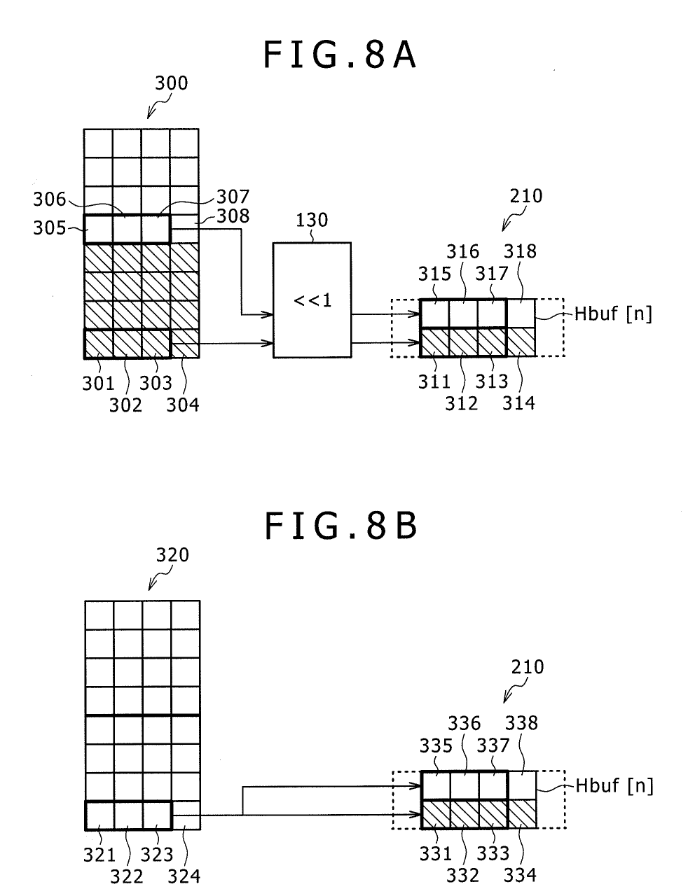

The motion-vector flows in the typical model shown in FIGS. 8A and 8B are motion-vector flows of processing to store motion vectors Mv in the unit Hbuf[n] of the motion-vector storage area 210 included in the motion-vector buffer 200. To be more specific, FIG. 8A is a diagram showing a model of motion-vector flows in processing to store motion vectors Mv for macro block pairs 300 each having the field structure in the unit Hbuf[n] of the motion-vector storage area 210 whereas FIG. 8B is a diagram showing a model of motion-vector flows in processing to store motion vectors Mv for macro block pairs 320 each having the frame structure in the unit Hbuf[n] of the motion-vector storage area 210.

As shown in FIG. 8A, in the case of a processing-subject macro block pair 300 having the field structure, motion vectors Mv of the top field of the processing-subject macro block pair 300 and motion vectors Mv of the bottom field of the processing-subject macro block pair 300 are stored in the unit Hbuf[n] of the motion-vector storage area 210. In the typical model shown in FIG. 8A, the top field of the processing-subject macro block pair 300 is shown as a white rectangular block whereas the bottom field of the processing-subject macro block pair 300 is shown as a hatched rectangular block.

To put it more concretely, in the case of a processing-subject macro block pair 300 having the field structure, the lowermost row of the top field of the processing-subject macro block pair 300 includes macro blocks 305 to 308 whereas the lowermost row of the bottom field of the processing-subject macro block pair 300 includes of macro blocks 301 to 304. Each of the motion vectors Mv computed for the macro blocks 305 to 307 and 301 to 303 is a motion vector Mv to be stored in the motion-vector storage area 210. To put it in detail, the motion-vector correction section 130 corrects the motion vectors Mv computed for the macro blocks 305 to 308 and 301 to 304 by doubling the value of the Y-axis component of each of the motion vectors Mv computed for the macro blocks 305 to 308 and 301 to 304. Then, the address conversion section 140 stores the corrected motion vectors Mv computed for the macro blocks 305 to 307 and 301 to 303 in the unit Hbuf[n] of the motion-vector storage area 210 at addresses assigned to the macro blocks 305 to 307 and 301 to 303 respectively.

To be more specific, the corrected motion vector Mv computed for the macro block 301 is stored in a storage area 311 in the unit Hbuf[n]. By the same token, the corrected motion vector Mv computed for the macro block 302 is stored in a storage area 312 in the unit Hbuf[n]. In the same way, the corrected motion vector Mv computed for the macro block 303 is stored in a storage area 313 in the unit Hbuf[n].

Likewise, the corrected motion vector Mv computed for the macro block 305 is stored in a storage area 315 in the unit Hbuf[n]. By the same token, the corrected motion vector Mv computed for the macro block 306 is stored in a storage area 316 in the unit Hbuf[n]. In the same way, the corrected motion vector Mv computed for the macro block 307 is stored in a storage area 317 in the unit Hbuf[n].

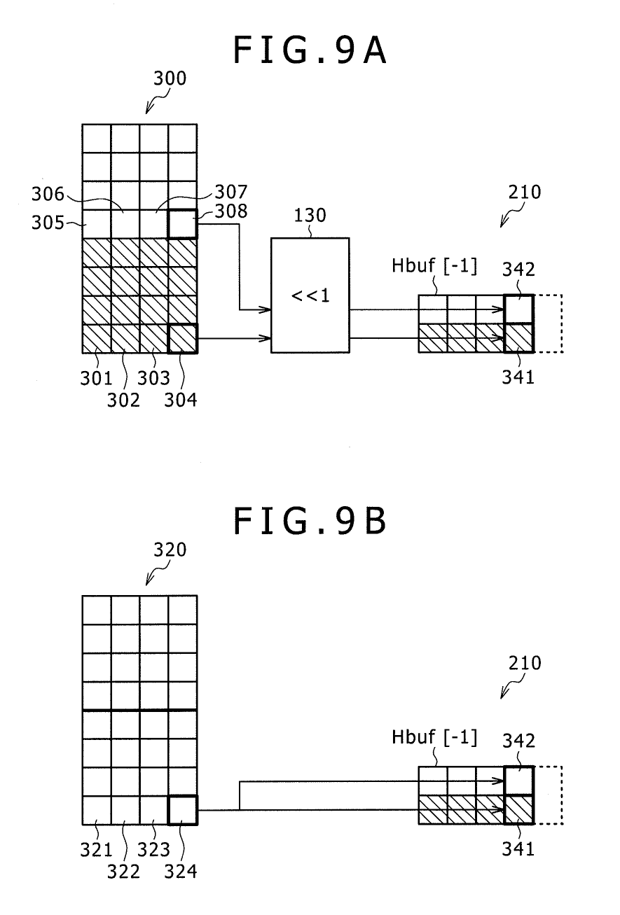

Motion vectors Mv stored in the unit Hbuf[n] include motion vectors Mv stored in the rightmost storage areas 314 and 318 of the unit Hbuf[n]. It is quite within the bounds of possibility that each of the motion vectors Mv stored in the rightmost storage areas 314 and 318 of the unit Hbuf[n] is used in processing of the next macro blocks as a left upper referenced motion vector. For this reason, the corrected motion vector Mv computed for the rightmost macro block 304 on the bottom-field lowermost row including the macro blocks 301 to 304 is not stored in the rightmost storage area 314 in the unit Hbuf[n] whereas the corrected motion vector Mv computed for the rightmost macro block 308 on the top-field lowermost row including the macro blocks 305 to 308 is not stored in the rightmost storage area 318 in the unit Hbuf[n]. The corrected motion vector Mv computed for the rightmost macro block 304 and the corrected motion vector Mv computed for the rightmost macro block 308 are stored in storage areas which will be described later in detail by referring to FIGS. 9A and 9B.

As shown in FIG. 8B, in the case of a processing-subject macro block pair 320 having the frame structure, motion vectors Mv at the bottom of the processing-subject macro block pair 320 are stored in the unit Hbuf[n] of the motion-vector storage area 210. In the typical model shown in FIG. 8B, each of the macro blocks composing the processing-subject macro block pair 320 is shown as a white rectangular block.

To put it more concretely, in the case of a processing-subject macro block pair 320 having the frame structure, the lowermost row of the processing-subject macro block pair 320 includes macro blocks 321 to 324. Each of the motion vectors Mv computed for the macro blocks 321 to 324 is a motion vector Mv to be stored in the motion-vector storage area 210. Since the processing-subject macro block pair 320 has the frame structure, however, the motion-vector correction section 130 does not correct the motion vectors Mv. That is to say, the motion-vector correction section 130 supplies the motion vectors Mv computed for the macro blocks 321 to 324 to the address conversion section 140 without correcting the motion vectors Mv. Then, the address conversion section 140 stores the corrected motion vectors Mv computed for the macro blocks 321 to 323 in the unit Hbuf[n] of the motion-vector storage area 210 at addresses assigned to the macro blocks 321 to 323 respectively.

To be more specific, the corrected motion vector Mv computed for the macro block 321 is stored in storage areas 331 and 335 in the unit Hbuf[n]. By the same token, the corrected motion vector Mv computed for the macro block 322 is stored in storage areas 332 and 336 in the unit Hbuf[n]. In the same way, the corrected motion vector Mv computed for the macro block 323 is stored in storage areas 333 and 337 in the unit Hbuf[n].

As described above, in the case of a processing-subject macro block pair 320 having the frame structure, only the motion vectors of the bottom frame are stored in the motion-vector storage area 210. In this case, each of the motion vectors of the bottom frame is stored in the motion-vector storage area 210 to serve as referenced motion vectors of both the bottom and top fields of the processing-subject macro blocks and the motion vectors of the top frame are not used.

In addition, motion vectors Mv stored in the unit Hbuf[n] include motion vectors Mv stored in the rightmost storage areas 334 and 338 of the unit Hbuf[n]. As described above, it is quite within the bounds of possibility that each of the motion vectors Mv stored in the rightmost storage areas 334 and 338 of the unit Hbuf[n] is used in processing of the next macro blocks as a left upper referenced motion vector. For this reason, the motion vector Mv computed for the rightmost macro block 324 on the bottom row including the macro blocks 321 to 324 is not stored in the rightmost storage areas 334 and 338 in the unit Hbuf[n]. The motion vector Mv computed for the rightmost macro block 324 are stored in storage areas which will be described later in detail by referring to FIGS. 9A and 9B.

FIGS. 9A and 9B are plurality of diagrams each showing a model of motion-vector flows in processing to store motion vectors Mv in a unit Hbuf[−1] in the motion-vector storage area 210 of the motion-vector buffer 200 employed in the motion-vector computation apparatus 100 according to the first embodiment of the present invention. To be more specific, FIG. 9A is a diagram showing a model of motion-vector flows in processing to store motion vectors Mv computed for macro block pairs 300 each having the field structure in the motion-vector storage area 210 whereas FIG. 9B is a diagram showing a model of motion-vector flows in processing to store motion vectors Mv computed for macro block pairs 320 each having the frame structure in the motion-vector storage area 210.

It is to be noted that the macro block pair 300 shown in FIG. 9A as a macro block pair having the field structure is identical with the macro block pair 300 shown in FIG. 8A whereas the macro block pair 320 shown in FIG. 9B as a macro block pair having the frame structure is identical with the macro block pair 320 shown in FIG. 8B. By the same token, macro blocks included in the macro block pairs 300 and 320 shown in FIGS. 9A and 9B are identical with the macro blocks included in the macro block pairs 300 and 320 shown in FIGS. 8A and 8B respectively. Thus, the following description makes use of the same reference numerals denoting the macro blocks included in the macro block pairs 300 and 320 shown in FIGS. 9A and 9B as the macro blocks included in the macro block pairs 300 and 320 shown in FIGS. 8A and 8B respectively.

As described earlier, it is quite within the bounds of possibility that each of the two motion vectors Mv stored in respectively the two rightmost storage areas of the unit Hbuf[n] is used as a left upper motion vector Mv in the processing of the next macro block.

Thus, for the reason described above, the corrected motion vector Mv computed for the rightmost macro block 304 on the bottom-field lowermost row including the macro blocks 301 to 304 is not stored in the rightmost storage area 314 in the unit Hbuf[n], but stored in a rightmost storage area 341 in the unit Hbuf[−1] whereas the corrected motion vector Mv computed for the rightmost macro block 308 on the top-field lowermost row including the macro blocks 305 to 308 is not stored in the rightmost storage area 318 in the unit Hbuf[n], but stored in a rightmost storage area 342 in the unit Hbuf[−1] instead as shown in FIG. 9A. From the timing point of view, after the data transfer processing explained earlier by referring to FIG. 7A has been carried out, the two motion vectors computed for the macro blocks 304 and 308 respectively are stored in respectively the rightmost storage areas 341 and 342 in the unit Hbuf[−1].

By the same token, for the same reason described above, the motion vector Mv computed for the rightmost macro block 324 on the bottom row including the macro blocks 321 to 324 is not stored in the rightmost storage areas 334 and 338 in the unit Hbuf[n], but stored in the rightmost storage areas 341 and 342 in the unit Hbuf[−1] instead as shown in FIG. 9B. From the timing point of view, after the data transfer processing explained earlier by referring to FIG. 7B has been carried out, the motion vector Mv computed for the rightmost macro block 324 is stored in the rightmost storage areas 341 and 342 in the unit Hbuf[−1].

### Typical Operations to Store Data in Motion-Vector Storage Areas Arranged in the Vertical Direction

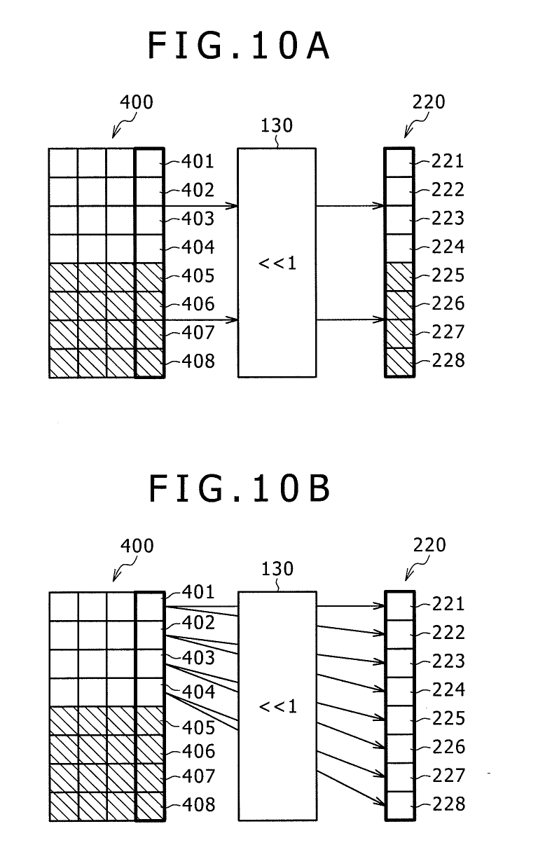

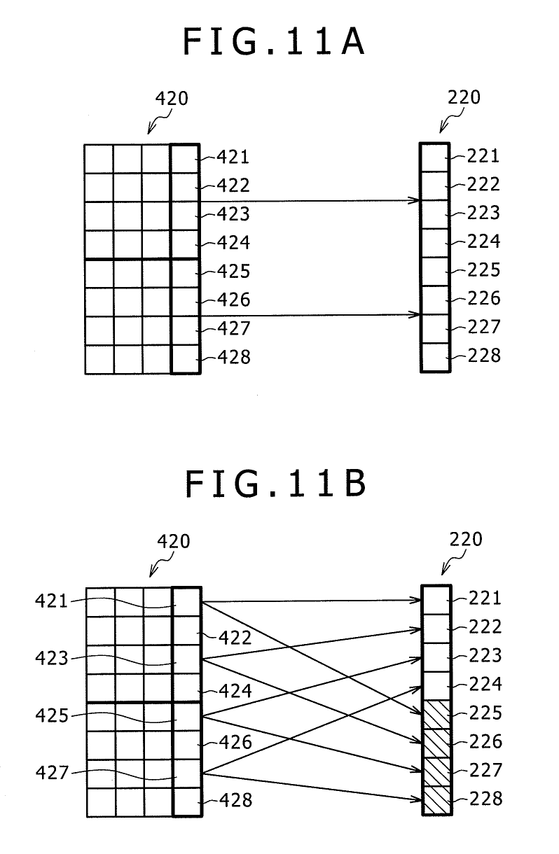

FIGS. 10A to 11B are diagrams each showing a model of motion-vector flows in processing to store motion vectors Mv in the motion-vector storage area 220 of the motion-vector buffer 200 employed in the motion-vector computation apparatus 100 according to the first embodiment of the present invention. Each of the typical models shown in FIGS. 10A to 11B can be applied to data storing processing which is carried out by consideration of whether the structure of the next processing-subject macro block is the frame or field structure. Since the structure of the present next processing-subject macro block is also the frame or field structure, there are four combinations of the frame and field structures of the present processing-subject macro block and the frame and field structures of the next processing-subject macro block as shown in FIGS. 10A to 11B described as follows.

FIGS. 10A and 10B are plurality of diagrams each showing a model of motion-vector flows in processing to store motion vectors Mv of a processing-subject macro block pair 400 having the field structure in the motion-vector storage area 220 of the motion-vector buffer 200. To be more specific, FIG. 10A shows a case in which the structure of the next processing-subject macro block is also the field structure. On the other hand, FIG. 10B shows a case in which the structure of the next processing-subject macro block is the frame structure.

If the structure of the next processing-subject macro block is the field structure, as shown in FIG. 10A, the motion-vector correction section 130 corrects the value of the Y-axis component of every motion vector Mv to be stored in the motion-vector storage area 220. After the motion-vector correction section 130 corrects the value of the Y-axis component of the motion vector Mv, the motion-vector correction section 130 stores the motion vector Mv in the motion-vector storage area 220. To put it more concretely, the motion-vector correction section 130 corrects the value of the Y-axis component of the motion vector Mv computed for each of macro blocks 401 to 408 which compose the processing-subject macro block pair 400 having the field structure. After the motion-vector correction section 130 corrects the value of the Y-axis component of each of the macro vectors Mv, the motion-vector correction section 130 stores the eight macro vectors Mv in respectively storage areas 221 to 228 of the motion-vector storage area 220.

To be more specific, the motion-vector correction section 130 corrects the value of the Y-axis component of each of the motion vectors Mv computed for the macro blocks 401 to 408 of the processing-subject macro block pair 400 and, then, stores eight macro vectors Mv in the storage areas 221 to 228 of the motion-vector storage area 220, respectively.

If the structure of the next processing-subject macro block is the frame structure, on the other hand, as shown in FIG. 10B, the motion-vector correction section 130 also corrects the value of the Y-axis component of every motion vector Mv to be stored in the motion-vector storage area 220. After the motion-vector correction section 130 corrects the value of the Y-axis component of the motion vector Mv, the motion-vector correction section 130 stores the motion vector Mv in the motion-vector storage area 220. To put it more concretely, the motion-vector correction section 130 corrects the value of the Y-axis component of the motion vector Mv computed for each of macro blocks 401 to 404 which are included in the processing-subject macro block pair 400 having the field structure. After the motion-vector correction section 130 corrects the value of the Y-axis component of each of the macro vectors Mv, the motion-vector correction section 130 stores the four macro vectors Mv in storage areas 221 to 228 of the motion-vector storage area 220.

To be more specific, the motion-vector correction section 130 corrects the value of the Y-axis component of the motion vector Mv computed for the macro block 401 of the processing-subject macro block pair 400 and, then, stores the macro vector Mv in the storage areas 221 and 222 of the motion-vector storage area 220. By the same token, the motion-vector correction section 130 corrects the value of the Y-axis component of the motion vector Mv computed for the macro block 402 of the processing-subject macro block pair 400 and, then, stores the macro vector Mv in the storage areas 223 and 224 of the motion-vector storage area 220. In the same way, the motion-vector correction section 130 corrects the value of the Y-axis component of the motion vector Mv computed for the macro block 403 of the processing-subject macro block pair 400 and, then, stores the macro vector Mv in the storage areas 225 and 226 of the motion-vector storage area 220. Likewise, the motion-vector correction section 130 corrects the value of the Y-axis component of the motion vector Mv computed for the macro block 404 of the processing-subject macro block pair 400 and, then, stores the macro vector Mv in the storage areas 227 and 228 of the motion-vector storage area 220.

As described above, in the case of the next processing-subject macro block having the frame structure, motion vectors Mv computed for the top field are used as referenced motion vectors Mv for both the top and bottom frames of the processing-subject macro blocks and motion vectors Mv computed for the bottom field are not used.

FIGS. 11A and 11B are plurality of diagrams each showing a model of motion-vector flows in processing to store motion vectors Mv of a processing-subject macro block pair 420 having the frame structure in the motion-vector storage area 220 of the motion-vector buffer 200. To be more specific, FIG. 11A shows a case in which the structure of the next processing-subject macro block is the frame structure. On the other hand, FIG. 11B shows a case in which the structure of the next processing-subject macro block is the field structure.

If the structure of the next processing-subject macro block is the frame structure, as shown in FIG. 11A, the motion-vector correction section 130 does not correct the value of the Y-axis component of any motion vector Mv to be stored in the motion-vector storage area 220. That is to say, the motion-vector correction section 130 stores every motion vector Mv in the motion-vector storage area 220 without correction of the motion vector Mv. To put it more concretely, eight motion vectors Mv computed for respectively macro blocks 421 to 428 composing the macro block pair 420 having the frame structure are stored in respectively storage areas 221 to 228 of the motion-vector storage area 220 as they are. That is to say, in the same way as the motion-vector flows explained earlier by referring to FIG. 10A, in accordance with the vertical order in which the macro blocks 421 to 428 composing the macro block pair 420 are arranged in the macro block pair 420, the eight motion vectors Mv computed for respectively the macro blocks 421 to 428 are stored in respectively the storage areas 221 to 228 of the motion-vector storage area 220 as they are.

If the structure of the next processing-subject macro block is the field structure, on the other hand, as shown in FIG. 11B, the motion-vector correction section 130 does not correct the value of the Y-axis component of any motion vector Mv to be stored in the motion-vector storage area 220. That is to say, the motion-vector correction section 130 stores some motion vectors Mv in the motion-vector storage area 220 without correction of the motion vectors Mv. To put it more concretely, four motion vectors Mv computed for respectively macro blocks 421, 423, 425 and 427 included the macro block pair 420 having the frame structure are stored in storage areas 221 to 228 of the motion-vector storage area 220 as they are. That is to say, in this case, the motion vector Mv computed for the macro block 421 included the macro block pair 420 is stored in the storage areas 221 and 225 of the motion-vector storage area 220 as it is. By the same token, the motion vector Mv computed for the macro block 423 included the macro block pair 420 is stored in the storage areas 222 and 226 of the motion-vector storage area 220 as it is. In the same way, the motion vector Mv computed for the macro block 425 included the macro block pair 420 is stored in the storage areas 223 and 227 of the motion-vector storage area 220 as it is. Likewise, the motion vector Mv computed for the macro block 427 included the macro block pair 420 is stored in the storage areas 224 and 228 of the motion-vector storage area 220 as it is. As obvious from the above description, if the structure of the next processing-subject macro block 420 is the field structure, motion vectors Mv computed for macro blocks 422, 424, 426 and 428 are not used.

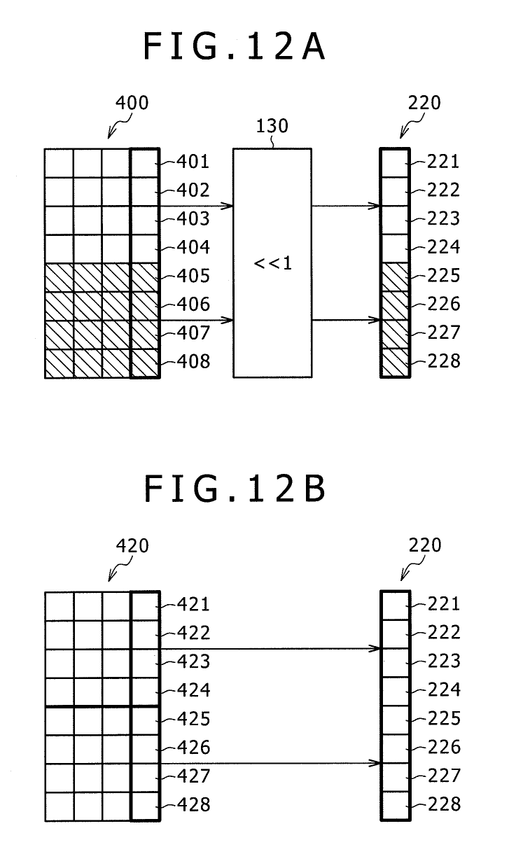

FIGS. 12A and 12B are plurality of diagrams each showing a model of motion-vector flows in processing to store motion vectors Mv in the motion-vector storage area 220 of the motion-vector buffer 200 employed in the motion-vector computation apparatus 100 according to the first embodiment of the present invention. Each of the typical models shown in FIGS. 12A and 12B can be applied to a data storing process which is carried out without regard to whether the structure of the next processing-subject macro block is the frame or field structure, that is, a data storing process which is carried out for the next processing-subject macro block with an unknown structure. In the case of the next processing-subject macro block with an unknown structure, the data storing process is carried out by assuming that the structure of the next processing-subject macro block is the same as the structure of the present processing-subject macro block. Since the structure of the present next processing-subject macro block is the field or frame structure, there are two combinations of the frame and field structures of the present processing-subject macro block and the unknown structure of the next processing-subject macro block as shown in FIGS. 12A and 12B.

FIG. 12A is a diagram showing a typical model of motion-vector flows in processing to store motion vectors Mv of a processing-subject macro block pair 400 having the field structure in the motion-vector storage area 220 of the motion-vector buffer 200 on the assumption that the structure of the next processing-subject macro block is also the field structure. On the other hand, FIG. 12B is a diagram showing a typical model of motion-vector flows in processing to store motion vectors Mv of a processing-subject macro block pair 420 having the frame structure in the motion-vector storage area 220 of the motion-vector buffer 200 on the assumption that the structure of the next processing-subject macro block is also the frame structure.

It is to be noted that the typical model shown in FIG. 12A is the same model as that shown in FIG. 10A whereas the typical model shown in FIG. 12B is the same model as that shown in FIG. 11A. For this reason, details of the typical models shown in FIGS. 12A and 12B are not explained in order to avoid duplications of descriptions.

Typical Operations to Load Data in Motion-Vector Prediction Processing for Next Processing-Subject Macro Blocks with an Unknown Structure

FIGS. 13A and 13B are plurality of diagrams each showing a typical model of motion-vector flows in processing to load motion vectors Mv from the motion-vector storage area 220 of the motion-vector buffer 200 employed in the motion-vector computation apparatus 100 according to the first embodiment of the present invention to a processing-subject macro block pair. To be more specific, FIG. 13A is a diagram showing a typical model of motion-vector flows in processing to load motion vectors Mv from the motion-vector storage area 220 to the next processing-subject macro block pair 451 having the field structure in the case of an immediately preceding macro block having the frame structure. On the other hand, FIG. 13B is a diagram showing a typical model of motion-vector flows in processing to load motion vectors Mv from the motion-vector storage area 220 to the next processing-subject macro block pair 452 having the frame structure in the case of an immediately preceding macro block having the field structure. The typical models shown in FIGS. 13A and 13B are obtained by modifying the typical models which are shown in FIGS. 5A and 5B respectively. However, each of FIGS. 13A and 13B shows only motion-vector flows in processing to load motion vectors Mv from the motion-vector storage area 220 to a processing-subject macro block pair.

An assumed case is described as follows. After the data storing process shown in FIG. 12A or 12B has been carried out for the next processing-subject macro block having an unknown structure, the motion-vector prediction processing for the next processing-subject macro block is carried forward and the structure of the next processing-subject macro block is identified. As described earlier, the structure of the present macro block serving as the subject of the motion-vector prediction processing can be the frame or field structure and the structure of the left-side referenced macro block can be the frame or field structure as well. The method for carrying out the process to load each of referenced motion vectors arranged in the vertical direction as shown in FIG. 13A or 13B is changed only if the structure of the present macro block serving as the subject of the motion-vector prediction processing is different from the structure of the left-side referenced macro block.

As described above, the method for carrying out the process to load each of referenced motion vectors arranged in the vertical direction as shown in FIG. 13A or 13B is changed only if the structure of the present macro block serving as the subject of the motion-vector prediction processing is different from the structure of the left-side referenced macro block. Thus, if macro blocks serving as the subject of the motion-vector prediction processing appear successively as macro blocks which have the same structure, the processing speed can be increased. For example, the structure of the present macro block serving as the subject of the motion-vector prediction processing can be assumed to be the same as the structure of the left-side referenced macro block in a certain area. That is to say, the structure of the present macro block serving as the subject of the motion-vector prediction processing and the structure of the left-side referenced macro block can be assumed to be both the frame or field structure in the certain area. In this case, it is possible to further increase the speed of the motion-vector computation process carried out as a part of the processing to predict a motion vector.

### Typical Data Loading in Deblocking Mode Processing

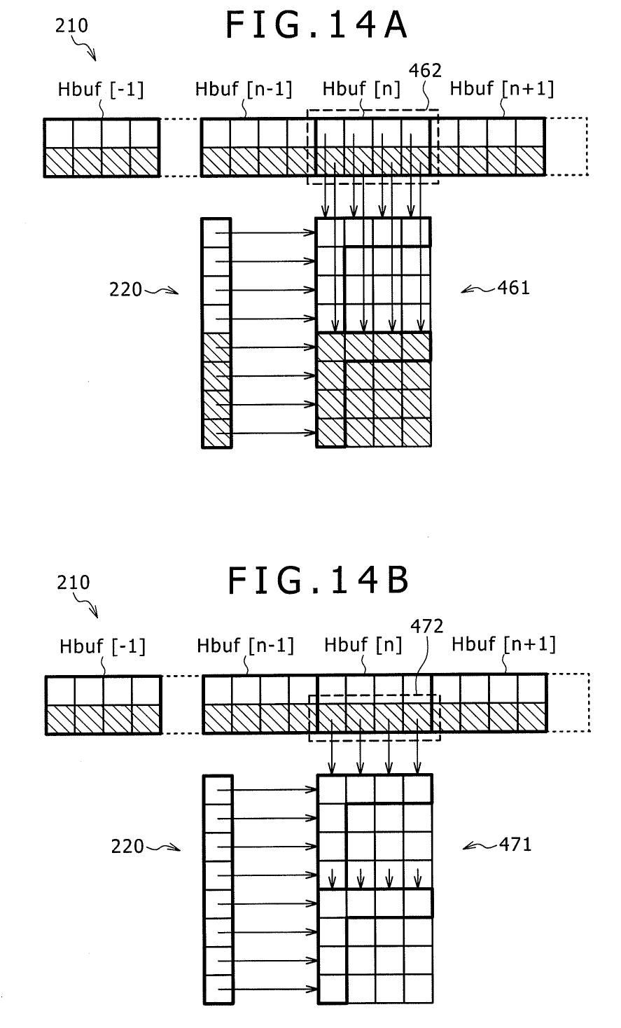

FIGS. 14A and 14B are plurality of diagrams each showing a typical model of motion-vector flows in deblocking mode processing carried out by the motion-vector computation apparatus 100 according to the first embodiment of the present invention. A motion vector Mv stored in the motion-vector buffer 200 can be used also in the deblocking mode processing. In each of the typical models shown in FIGS. 14A and 14B, motion vectors Mv stored in the motion-vector storage areas 210 and 220 of the motion-vector buffer 200 are used in the deblocking mode processing.

To be more specific, FIG. 14A is a diagram showing a typical model of motion-vector flows in deblocking mode processing carried out in the case of a processing-subject macro block pair 461 having the field structure. On the other hand, FIG. 14B is a diagram showing a typical model of motion-vector flows in deblocking mode processing carried out in the case of a processing-subject macro block pair 471 having the frame structure. It is to be noted that motion vectors Mv of macro blocks enclosed by a dashed line 462 shown in FIG. 14A are motion vectors Mv stored in the motion-vector storage area 210 to serve as motion vectors Mv to be loaded from the motion-vector storage area 210. By the same token, motion vectors Mv of macro blocks enclosed by a dashed line 472 shown in FIG. 14B are motion vectors Mv stored in the motion-vector storage area 210 to serve as motion vectors Mv to be loaded from the motion-vector storage area 210.

The motion-vector flows shown in FIG. 14A for a processing-subject macro block pair having the field structure are different from the motion-vector flows shown in FIG. 14B for a processing-subject macro block pair having the frame structure as the motion-vector flows shown in FIG. 5A for a processing-subject macro block pair having the field structure are different from the motion-vector flows shown in FIG. 5B. As described earlier, however, the value of the Y-axis component of every referenced vector stored in the motion-vector buffer 200 has been fixed to a value compatible with the frame structure and, in addition, each of such referenced vectors has been stored in the motion-vector buffer 200 at an address determined in advance. Thus, in the same way as the motion-vector prediction processing explained before by referring to FIGS. 5A and 5B, an address from which a referenced motion vector is to be loaded from the motion-vector buffer 200 can be determined in advance in accordance with the structure of the processing-subject macro block pair.

As obvious from the above description, a motion vector on a macro block boundary can be said to be approximately the same as a referenced motion vector to be used in motion-vector prediction processing. It is thus possible to reduce the cost of making an access to a motion vector in deblocking mode processing. In addition, an address conversion process of the deblocking mode processing is made unnecessary. Thus, the deblocking mode processing can be carried out at a high speed.

In addition, even though the macro block structure which can be the frame or field structure has an effect also on the deblocking mode processing, the process to identify the structure of a macro block can be made unnecessary because every referenced motion vector has been fixed at a value set for the frame prediction processing.

### Typical Operations of a Picture Taking Apparatus

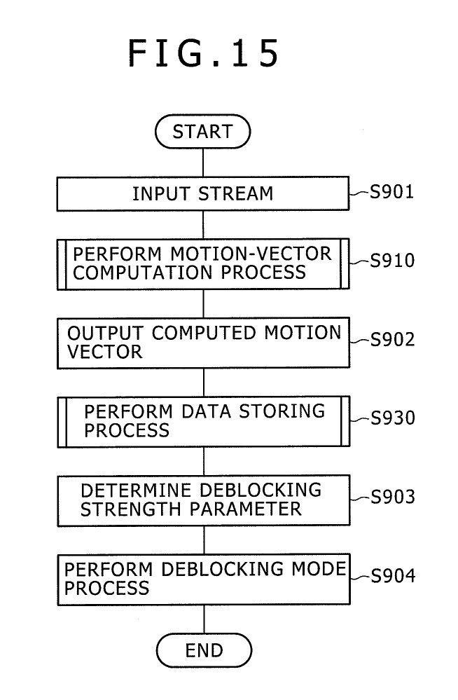

FIG. 15 shows a flowchart representing the procedure of moving-picture decoding processing carried out by the motion-vector computation apparatus 100 according to the first embodiment of the present invention.

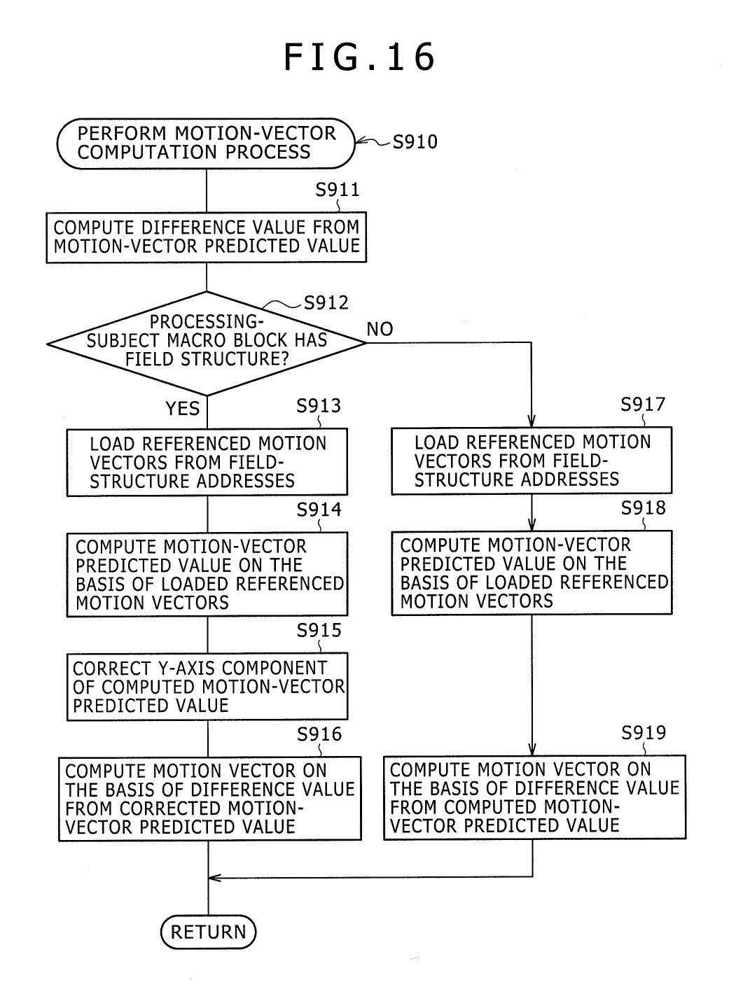

The flowchart shown in the figure begins with a step S901 at which the motion-vector computation apparatus 100 receives an input stream. Then, at the next step S910, the motion-vector computation apparatus 100 carries out a motion-vector computation process. This motion-vector computation process will be explained later in detail by referring to a flowchart shown in FIG. 16. It is to be noted that the motion-vector computation process carried out at the step S910 is a typical example of a motion-vector computation procedure described in a claim appended to this invention specification.

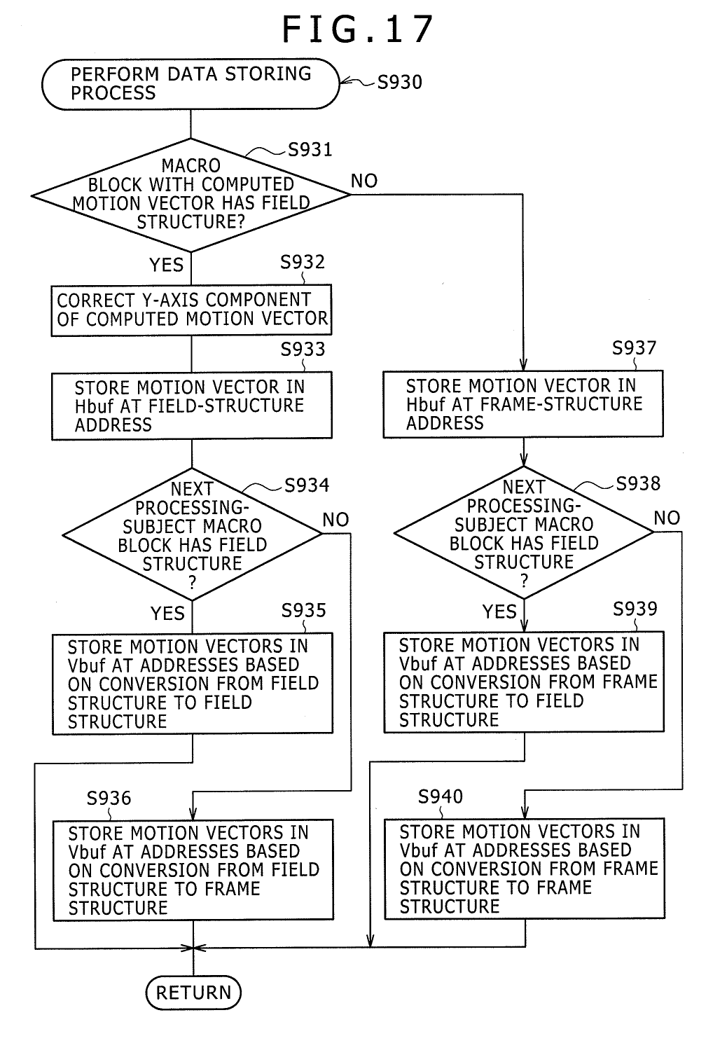

Subsequently, at the next step S902, the motion-vector computation apparatus 100 outputs the motion vector computed at the step S910. Then, at the next step S930, the motion-vector computation apparatus 100 carries out a data storing process. This data storing process will be explained later in detail by referring to a flowchart shown in FIG. 17.

Subsequently, at the next step S903, the deblocking mode parameter determination section 181 employed in the motion-vector computation apparatus 100 determines a deblock strength parameter BsV whereas the deblocking mode parameter determination section 182 also employed in the motion-vector computation apparatus 100 determines a deblock strength parameter BsH. Then, at the next step S904, a deblocking mode processing is carried out by making use of the deblock strength parameter BsV and the deblock strength parameter BsH.

FIG. 16 shows a flowchart representing the procedure of a motion-vector computation process carried out by the motion-vector computation apparatus 100 according to the first embodiment of the present invention at the step S910 of the flowchart shown in FIG. 15 as a part of the moving-picture decoding processing represented by the flowchart shown in FIG. 15.

The flowchart shown in FIG. 16 begins with a step S911 at which the arithmetic decoding processing section 110 carries out an arithmetic decoding process on the input stream in order to compute a difference value Mvd from the predicted value of the motion vector. Then, the flow of the motion-vector computation process goes on to the next step S912 to produce a result of determination as to whether or not the structure of the processing-subject macro block is the field structure.

If the determination result produced at the step S912 indicates that the structure of the processing-subject macro block is indeed the field structure, the flow of the motion-vector computation process goes on to a step S913 at which the motion-vector predicted-value computation section 160 loads a referenced motion vector for the field structure from the motion-vector buffer 200. Then, at the next step S914, the motion-vector predicted-value computation section 160 computes a motion-vector predicted value Mvp of the processing-subject macro block on the basis of the referenced motion vector which has been loaded from the motion-vector buffer 200.

Subsequently, at the next step S915, the motion-vector predicted-value correction section 170 corrects the motion-vector predicted value Mvp by doubling the value of the Y-axis component of the motion-vector predicted value Mvp which has been computed by the motion-vector predicted-value computation section 160. Then, at the next step S916, the adder 120 adds the difference value Mvd found by the arithmetic decoding processing section 110 at the step S911 to the motion-vector predicted value Mvp corrected by the motion-vector predicted-value correction section 170 at the step S915 in order to compute the motion vector Mv of the processing-subject macro block.

If the determination result produced at the step S912 indicates that the structure of the processing-subject macro block is the frame structure, on the other hand, the flow of the motion-vector computation process goes on to a step S917 at which the motion-vector predicted-value computation section 160 loads a referenced motion vector for the frame structure from the motion-vector buffer 200. Then, at the next step S918, the motion-vector predicted-value computation section 160 computes a motion-vector predicted value Mvp of the processing-subject macro block on the basis of the referenced motion vector which has been loaded from the motion-vector buffer 200.

Subsequently, at the next step S919, the adder 120 adds the difference value Mvd found by the arithmetic decoding processing section 110 at the step S911 to the motion-vector predicted value Mvp computed by the motion-vector predicted-value computation section 160 at the step S918 in order to compute the motion vector Mv of the processing-subject macro block.

FIG. 17 shows a flowchart representing the procedure of a data storing process carried out by the motion-vector computation apparatus 100 according to the first embodiment of the present invention at the step S930 of the flowchart shown in FIG. 15 as a part of the moving-picture decoding processing represented by the flowchart shown in FIG. 15.

The flowchart shown in FIG. 17 begins with a step S931 to produce a result of determination as to whether or not the structure of the processing-subject macro block with its motion vector Mv already computed by the adder 120 at the step S910 of the flowchart shown in FIG. 15 is the field structure. If the determination result produced at the step S931 indicates that the structure of the processing-subject macro block is indeed the field structure, the flow of the motion-vector storing process goes on to a step S932 at which the motion-vector correction section 130 corrects the motion vector Mv, which has been computed by the adder 120 at the step S910 of the flowchart shown in FIG. 15, by doubling the value of the Y-axis component of the motion vector Mv. It is to be noted that the process carried out at the step S932 is a typical example of a motion-vector correction procedure described in a claim appended to this invention specification. Then, at the next step S933, the address conversion section 140 stores the motion vector Mv corrected at the step S932 in the motion-vector storage area 210 of the motion-vector buffer 200 at an address set for the field structure.

Subsequently, the flow of the data storing process goes on to the next step S934 to produce a result of determination as to whether or not the structure of the next processing-subject macro block is the field structure. If the determination result produced at the step S934 indicates that the structure of the next processing-subject macro block is indeed the field structure, the flow of the motion-vector storing process goes on to a step S935 at which the address conversion section 140 stores the motion vector Mv corrected at the step S932 in the motion-vector storage area 220 of the motion-vector buffer 200 at an address obtained as a result of conversion from the field structure into the field structure. That is to say, the address conversion section 140 stores the motion vector Mv corrected at the step S932 in the motion-vector storage area 220 of the motion-vector buffer 200 at an address set for the field structure. A typical example of the process carried out at the step S935 to store the corrected motion vector Mv in the motion-vector storage area 220 is the operation explained earlier by referring to FIG. 10A.

If the determination result produced at the step S934 indicates that the structure of the next processing-subject macro block is the frame structure, on the other hand, the flow of the motion-vector storing process goes on to a step S936 at which the address conversion section 140 stores the motion vector Mv corrected at the step S932 in the motion-vector storage area 220 of the motion-vector buffer 200 at an address obtained as a result of conversion from the field structure into the frame structure. That is to say, the address conversion section 140 stores the motion vector Mv corrected at the step S932 in the motion-vector storage area 220 of the motion-vector buffer 200 at an address set for the frame structure. A typical example of the process carried out at the step S936 to store the corrected motion vector Mv in the motion-vector storage area 220 is the operation explained earlier by referring to FIG. 10B.

By the way, if the determination result produced at the step S931 indicates that the structure of the processing-subject macro block is the frame structure, on the other hand, the flow of the motion-vector storing process goes on to a step S937 at which the address conversion section 140 stores the motion vector Mv corrected at the step S932 in the motion-vector storage area 210 of the motion-vector buffer 200 at an address set for the frame structure.

Subsequently, the flow of the motion-vector storing process goes on to the next step S938 to produce a result of determination as to whether or not the structure of the next processing-subject macro block is the field structure. If the determination result produced at the step S938 indicates that the structure of the next processing-subject macro block is indeed the field structure, the flow of the motion-vector storing process goes on to a step S939 at which the address conversion section 140 stores the motion vector Mv computed at the step S910 in the motion-vector storage area 220 of the motion-vector buffer 200 at an address obtained as a result of conversion from the frame structure into the field structure. That is to say, the address conversion section 140 stores the motion vector Mv computed at the step S910 in the motion-vector storage area 220 of the motion-vector buffer 200 at an address set for the field structure. A typical example of the process carried out at the step S939 to store the corrected motion vector Mv in the motion-vector storage area 220 is the operation explained earlier by referring to FIG. 11B.

If the determination result produced at the step S938 indicates that the structure of the next processing-subject macro block is the frame structure, on the other hand, the flow of the motion-vector storing process goes on to a step S940 at which the address conversion section 140 stores the motion vector Mv computed at the step S910 in the motion-vector storage area 220 of the motion-vector buffer 200 at an address obtained as a result of conversion from the frame structure into the frame structure. That is to say, the address conversion section 140 stores the motion vector Mv computed at the step S910 in the motion-vector storage area 220 of the motion-vector buffer 200 at an address set for the frame structure. A typical example of the process carried out at the step S940 to store the corrected motion vector Mv in the motion-vector storage area 220 is the operation explained earlier by referring to FIG. 11A.

It is to be noted that the processes carried out at the steps S933, S935, S936, S937, S939 and S940 are a typical example of a motion-vector storing procedure described in a claim appended to this invention specification.

### 2. Second Embodiment

The first embodiment of the present invention implements a typical configuration of the motion-vector computation apparatus in which the motion vector of a processing-subject macro block is computed by referencing motion vectors of macro blocks surrounding the processing-subject macro block. On the other hand, a second embodiment of the present invention implements another typical configuration of the motion-vector computation apparatus in which the motion vector of a processing-subject macro block is computed by referencing motion vectors of macro blocks of another frame referred to as a referenced frame different from the frame which includes the processing-subject macro block. That is to say, the second embodiment of the present invention implements another typical configuration in which the motion vector of a processing-subject macro block is computed in the so-called direct mode.

As described before, each of the structure of a motion vector computed for a referenced frame and the structure of the processing-subject macro block is a frame or field structure. In general, if the structure of a motion vector computed for a referenced frame is different from the structure of the processing-subject macro block, it is necessary to correct the value of the Y-component of the motion vector computed for the referenced frame. If the structure of a motion vector computed for a referenced frame is the field structure whereas the structure of the processing-subject macro block is the frame structure for example, it is necessary to correct the value of the Y-component of the motion vector computed for the referenced frame by doubling the value of the Y-component of the motion vector. If the structure of a motion vector computed for a referenced frame is the frame structure whereas the structure of the processing-subject macro block is the field structure, on the other hand, it is necessary to correct the value of the Y-component of the motion vector computed for the referenced frame by halving the value of the Y-component of the motion vector.

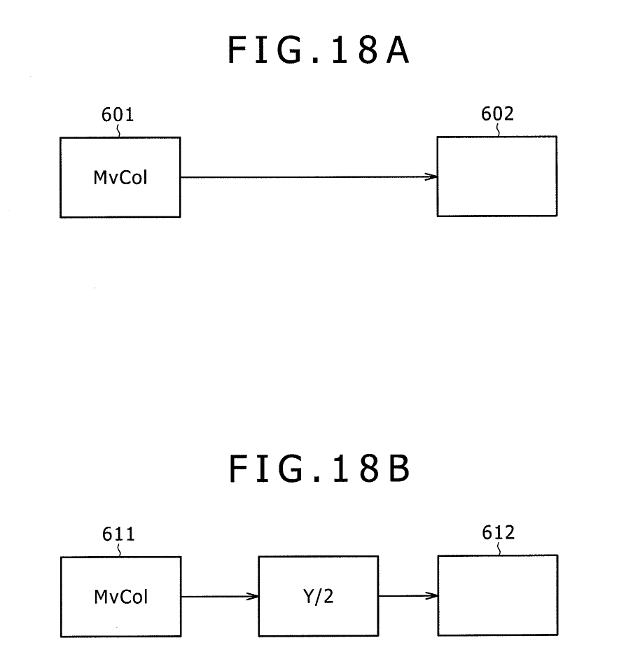

FIGS. 18A and 18B are plurality of diagrams each showing a model of a method for correcting a motion vector of a referenced frame in a direct mode process carried out by a motion-vector computation apparatus according to the second embodiment of the present invention. In the motion-vector computation apparatus according to the second embodiment of the present invention, a referenced motion vector used in the motion-vector prediction processing carried out by the motion-vector computation apparatus according to the first embodiment of the present invention is used in the direct mode processing. Thus, the motion-vector correction processing can be made simpler. It is to be noted that the referenced motion vector used in the motion-vector prediction processing carried out by the motion-vector computation apparatus according to the first embodiment of the present invention is a motion vector already corrected to a motion vector which is compatible with the frame structure.

FIG. 18A is a diagram showing a configuration of making use of a referenced-frame motion vector 602 obtained by not correcting a referenced-frame motion vector 601 already corrected to a motion vector compatible with the frame structure for an assumed typical case in which the structure of the motion vector 601 of a referenced frame is the field structure whereas the structure of a processing-subject macro block is the frame structure so that the motion vector 601 already corrected to a motion vector compatible with the frame structure is not corrected in the direct mode processing can be used to serve as the motion vector 602 of the referenced frame. Reference notation MvCol shown in FIG. 18A denotes the motion vector 601 computed for an anchor block of the referenced frame.

It is to be noted that FIG. 18B is a diagram showing another configuration of making use of a referenced-frame motion vector 612 obtained by correcting a referenced frame motion vector 611 in the direct mode processing by halving the value of the Y-axis component of the motion vector 611 for another assumed typical case in which the structure of the motion vector 611 of a referenced frame is the frame structure whereas the structure of a processing-subject macro block is the field structure so that the motion vector 611 corrected in the direct mode processing can be used to serve as the motion vector 612 of the referenced frame.

In this case, up to 32 motion vectors are used for one macro block including 4×4 blocks which each require two motion vectors in the case of a 2-vector prediction process. That is to say, up to 32 motion vectors are used in a 2-vector prediction process. Thus, a memory having an extremely large storage capacity is required if all motion vectors of a frame to be referenced in the direct mode processing are to be stored in the memory. In order to solve this problem of the extremely large memory storage capacity, in the case of the second embodiment of the present invention, only motion vectors of surrounding macro blocks to be referenced in the direct mode processing are stored in the motion-vector buffer 200 to serve as referenced motion vectors in the same way as the first embodiment of the present invention. Thus, the utilization efficiency of the memory can be increased. As a result, it is possible to make use of a high-speed memory such as a cache.

As described above, in accordance with the first embodiment of the present invention, in the motion-vector prediction processing carried out by adoption of the H.264 method and the deblocking mode processing, the process to convert an address from which a motion vector is to be loaded is made unnecessary. Thus, the motion vector can be computed at a high speed.

In addition, for the processing to correct the structure from the frame structure to the field structure for example, it is necessary carry out a truncation process symmetrically with respect to an axis which separates the positive and negative sides from each other. Since the truncation process is not a right-shift operation, the cost of execution of the process is high. On the other hand, the Y-axis component of every referenced motion vector stored in the motion-vector buffer 200 is fixed at a value which is compatible with the frame structure. It is thus necessary to carry out a process of correcting the structure of every motion vector to be stored in the motion-vector buffer 200 from the field structure to the frame structure. Since the process of correcting the structure of every motion vector to be stored in the motion-vector buffer 200 from the field structure to the frame structure is merely a left-shift operation, however, the cost of execution of the process can be reduced substantially.

On top of that, in order to fix the Y-axis component of every referenced motion vector to be stored in the motion-vector buffer 200 at a value which is compatible with the frame structure, the number of operations to correct a referenced motion vector can be reduced. In addition, for the correction operations such as a conditional branch process and a process of truncation symmetrical with respect to an axis separating the positive and negative sides from each other, the cost of execution of a process to set a frame prediction processing value at a fixed value is very low. Thus, the correction operations can be carried out at a high speed.

It is to be noted that each of the first and second embodiments of the present invention is merely a typical implementation of the present invention. As obviously revealed in the descriptions of the first and second embodiments provided by the present invention, each of the inventions described in the embodiments corresponds to one of inventions described in claims appended to this invention specification. By the same token, each particular one of the inventions described in the claims appended to this invention specification corresponds to one the inventions described in the embodiments of the present invention as an invention which has the same name as the particular invention described in the claims. Nonetheless, implementations of the present invention are by no means limited to the first and second embodiments of the present invention. That is to say, in order to implement the present invention, each of the first and second embodiments of the present invention can be changed to any one of a variety of modified versions within a range which does not deviate from essentials of the present invention.

In addition, each of the processing procedures according to the first embodiment of the present invention can be interpreted as a method for carrying out a sequence of processes to implement the method or interpreted as a program to be executed by a computer for carrying out the sequence of processes and as a recording medium used for storing the program. Typical examples of the recording medium are a CD (Compact Disc), an MD (Mini Disc), a DVD (Digital Versatile Disk), a memory card and a Blu-ray disc (a trade mark).

The present application contains subject matter related to that disclosed in Japanese Priority Patent Application JP 2009-205648 filed in the Japan Patent Office on Sep. 7, 2009, the entire content of which is hereby incorporated by reference.

It should be understood by those skilled in the art that a variety of modifications, combinations, sub-combinations and alterations may occur, depending on design requirements and other factors as far as they are within the scope of the appended claims or the equivalents thereof.

What is claimed is:

1. A motion-vector computation apparatus comprising:
a motion-vector correction section configured to correct a referenced motion vector to be used in a process to compute a motion vector of a second macro block pair so as to make said referenced motion vector compatible with a specific structure, wherein
said referenced motion vector is one of motion vectors already computed for a first macro block pair,
each of said first and second macro block pairs is a macro block pair having a frame structure or a field structure,
said macro block pairs each having a frame structure or a field structure are each a macro block pair obtained as a result of respectively a frame encoding or field encoding process carried out as encoding processing for every macro block pair by switching said encoding processing from said frame encoding process to said field encoding process and vice versa, and
said specific structure is either said frame structure or said field structure;
a motion-vector holding section configured to store said referenced motion vector corrected to a motion vector compatible with said specific structure at an address determined in accordance with the structure of said first macro block pair; and
a motion-vector computation section configured to read out said referenced motion vector from said motion-vector holding section in accordance with the structure of said second macro block pair and compute a motion vector of said second macro block pair on the basis of said referenced motion vector read out from said motion-vector holding section.

2. The motion-vector computation apparatus according to claim 1, wherein
said motion-vector correction section takes said frame structure as said specific structure and corrects said referenced motion vector so as to make said referenced motion vector compatible with said frame structure.

3. The motion-vector computation apparatus according to claim 2, wherein,
if said first macro block pair has said field structure, said motion-vector correction section corrects said referenced motion vector by doubling the vertical-direction component of said referenced motion vector but, if said first macro block pair has said frame structure, on the other hand, said motion-vector correction section does not correct said referenced motion vector.

4. The motion-vector computation apparatus according to claim 2, further comprising:
a motion-vector predicted-value computation section configured to compute a predicted value of a motion vector of said second macro block pair on the basis of said referenced motion vector read out from said motion-vector holding section; and
a motion-vector predicted-value correction section configured to correct said predicted value of said motion vector so as to make said predicted value of said motion vector compatible with said field structure of said second macro block pair in case said second macro block pair has said field structure.

5. The motion-vector computation apparatus according to claim 4, wherein,
if said second macro block pair has said field structure, said motion-vector predicted-value correction section corrects said predicted value of said motion vector by halving said vertical-direction component of said predicted value of said motion vector but, if said second macro block pair has said frame structure, on the other hand, said motion-vector correction section does not correct said predicted value of said motion vector.

6. The motion-vector computation apparatus according to claim 1, further comprising
a parameter determination section configured to determine parameters, which are to be used in deblocking mode processing related to said second macro block pair, on the basis of said referenced motion vectors read out from said motion-vector holding section and on the basis of a motion vector computed for said second macro block pair and corrected so as to make said motion vector compatible with said specific structure.

7. A motion-vector computation method comprising the steps of:
correcting a referenced motion vector to be used in a process to compute a motion vector of a second macro block pair so as to make said referenced motion vector compatible with a specific structure, wherein
said referenced motion vector is one of motion vectors already computed for a first macro block pair,
said first and second macro block pairs are macro block pairs each having a frame structure or a field structure,
said macro block pairs each having a frame structure or a field structure are each a macro block pair obtained as a result of respectively a frame encoding or field encoding process carried out as encoding processing for every macro block pair by switching said encoding processing from said frame encoding process to said field encoding process and vice versa, and
said specific structure is either said frame structure or said field structure;
storing said referenced motion vector corrected to a motion vector compatible with said specific structure at an address determined in accordance with the structure of said first macro block pair; and
reading out said referenced motion vector from said motion-vector holding procedure in accordance with the structure of said second macro block pair and computing a motion vector of said second macro block pair on the basis of said referenced motion vector read out from said motion-vector holding procedure.

8. A motion-vector computation program to be executed by a computer in order to carry out:
a motion-vector correction procedure for correcting a referenced motion vector to be used in a process to compute a motion vector of a second macro block pair so as to make said referenced motion vector compatible with a specific structure, wherein
said referenced motion vector is one of motion vectors already computed for a first macro block pair,
said first and second macro block pairs are macro block pairs each having a frame structure or a field structure,
said macro block pairs each having a frame structure or a field structure are each a macro block pair obtained as a result of respectively a frame encoding or field encoding process carried out as encoding processing for every macro block pair by switching said encoding processing from said frame encoding process to said field encoding process and vice versa, and
said specific structure is either said frame structure or said field structure;
a motion-vector holding procedure for storing said referenced motion vector corrected to a motion vector compatible with said specific structure at an address determined in accordance with the structure of said first macro block pair; and
a motion-vector computation procedure for reading out said referenced motion vector from said motion-vector holding procedure in accordance with the structure of said second macro block pair and computing a motion vector of said second macro block pair on the basis of said referenced motion vector read out from said motion-vector holding procedure.

9. A motion-vector computation apparatus comprising:
motion-vector correction means for correcting a referenced motion vector to be used in a process to compute a motion vector of a second macro block pair so as to make said referenced motion vector compatible with a specific structure, wherein
said referenced motion vector is one of motion vectors already computed for a first macro block pair,
each of said first and second macro block pairs is a macro block pair having a frame structure or a field structure,
said macro block pairs each having a frame structure or a field structure are each a macro block pair obtained as a result of respectively a frame encoding or field encoding process carried out as encoding processing for every macro block pair by switching said encoding processing from said frame encoding process to said field encoding process and vice versa, and
said specific structure is either said frame structure or said field structure;
motion-vector holding means for storing said referenced motion vector corrected to a motion vector compatible with said specific structure at an address determined in accordance with the structure of said first macro block pair; and
motion-vector computation means for reading out said referenced motion vector from said motion-vector holding means in accordance with the structure of said second macro block pair and computing a motion vector of said second macro block pair on the basis of said referenced motion vector read out from said motion-vector holding means.
